(19) United States
(12) Patent Application Publication
(10) Pub. No.: US 2025/0199471 A1
(43) Pub. Date: Jun. 19, 2025

(54) ELECTRONIC DEVICE PROVIDING HOLOGRAPHIC IMAGE AND OPERATING METHOD OF ELECTRONIC DEVICE

(71) Applicant: SAMSUNG ELECTRONICS CO., LTD., Suwon-si (KR)

(72) Inventors: Jongin LEE, Suwon-si (KR); Kilsoo CHOI, Suwon-si (KR); Bonggil BAK, Suwon-si (KR); Youngmin PARK, Suwon-si (KR); Yongseok JANG, Suwon-si (KR); Sunghee CHO, Suwon-si (KR); Dongho LEE, Suwon-si (KR); Jaeneung LEE, Suwon-si (KR); Jaewon JUNG, Suwon-si (KR)

(73) Assignee: SAMSUNG ELECTRONICS CO., LTD., Suwon-si (KR)

(21) Appl. No.: 19/068,134

(22) Filed: Mar. 3, 2025

Related U.S. Application Data
(63) Continuation of application No. PCT/KR2023/012036, filed on Aug. 14, 2023.

(30) Foreign Application Priority Data
Sep. 15, 2022 (KR) 10-2022-0116683
Nov. 22, 2022 (KR) 10-2022-0157506

(51) Int. Cl. G03H 1/00; G03H 1/26

(52) U.S. Cl. CPC G03H 1/0005; G03H 1/268; G03H 2001/0088

(57) ABSTRACT

An electronic device includes: a display; memory storing at least one instruction; and at least one processor configured to execute the at least one instruction to cause the electronic device to: obtain an input image, obtain information about a guide area of the display, the guide area including a plurality of sub-guide areas having a plurality of different weights with respect to implementation of a holographic image, the holographic image being implemented via the hologram guide by reflecting a base image that is based on the input image, determine a display area in the guide area, in which the base image can be displayed to have a weight greater than a preset threshold, based on the input image and the information about the guide area, convert the input image into the base image based on the display area, and display the base image in the display area.

### CROSS-REFERENCE TO RELATED APPLICATIONS

This application is a continuation of International Application No. PCT/KR2023/012036, filed on Aug. 14, 2023, which is based on and claims priority to Korean Patent Application No. 10-2022-0116683, filed on Sep. 15, 2022, in the Korean Intellectual Property Office, and Korean Patent Application No. 10-2022-0157506, filed on Nov. 22, 2022, in the Korean Intellectual Property Office, the disclosures of which are incorporated by reference herein in their entireties.

### BACKGROUND

### 1. Field

The disclosure relates to an electronic device for providing a holographic image implemented by reflecting an image provided via a hologram guide, and an operating method of the electronic device.

### 2. Description of Related Art

With the development in a technology, various products or services for providing a three-dimensional (3D) stereoscopic image have been provided.

The 3D stereoscopic image may be provided, in consideration of a difference between a left-eye vision and a right-eye vision, or the 3D stereoscopic image may be provided by using a plurality of displays. Also, the 3D stereoscopic image may be provided by using a hologram technology using an interference effect of light.

A scheme of providing a 3D stereoscopic image by using the hologram technology includes a display configured to output an image and a floating image scheme of providing a 3D stereoscopic image by projecting an image onto a translucent hologram device, the image being output from the display.

### SUMMARY

According to an aspect of the disclosure, an electronic device includes: a display; memory storing at least one instruction; and at least one processor configured to execute the at least one instruction stored in the memory, wherein the at least one instruction, when executed by the at least one processor, causes the electronic device to: obtain an input image, obtain information about a guide area of the display, the guide area including a plurality of sub-guide areas having a plurality of different weights with respect to implementation of a holographic image, the holographic image being implemented via a hologram guide by reflecting a base image that is based on the input image, determine a display area in the guide area, in which the base image can be displayed to have a weight greater than a preset threshold, based on the input image and the information about the guide area, convert the input image into the base image based on the display area, and display the base image in the display area.

The at least one instruction, when executed by the at least one processor, may further cause the electronic device to: determine whether the display is connected to the hologram guide, based on determining that the display is connected to the hologram guide, display the base image in the display area of the display, and based on determining that the display is not connected to the hologram guide, display the input image on the display.

The at least one instruction, when executed by the at least one processor, may further cause the electronic device to: receive information about the hologram guide from the hologram guide, and obtain the information about the guide area based on the information about the hologram guide, and the information about the hologram guide includes at least one of a type of the hologram guide, a shape of the hologram guide, a number of at least one reflection surface of the hologram guide, an angle formed between the at least one reflection surface and the display, or a material of the at least one reflection surface.

The plurality of different weights may include a first weight, a second weight less than the first weight, and a third weight less than the second weight, the plurality of sub-guide areas may include a first sub-guide area having the first weight, a second sub-guide area having the second weight, and a third sub-guide area having the third weight, and a distance between the first sub-guide area and the second sub-guide area may be less than a distance between the first sub-guide area and the third sub-guide area.

The at least one instruction, when executed by the at least one processor, may further cause the electronic device to: receive, from a server or a neighboring electronic device which provides the input image, indication information including information about a target image based on the input image, the target image to be implemented as the holographic image; determine, based on the input image, the information about the guide area, and the indication information, the display area in which the base image for implementing the target image as the holographic image is to be displayed, convert the input image into the base image based on the display area and the indication information, and display the base image in the display area.

The at least one instruction, when executed by the at least one processor, may further cause the electronic device to: receive tag information including information indicating a portion of the input image as a main image, determine, based on the input image, the information about the guide area, and the tag information, the display area for allowing the base image for implementing the main image to be displayed in an area having a greatest weight among the plurality of sub-guide areas, convert the input image into the base image based on the display area and the tag information; and display the base image in the display area.

The plurality of different weights include a first weight and a second weight less than the first weight, the plurality of sub-guide areas may include a first sub-guide area having the first weight and a second sub-guide area having the second weight, the base image may include a first base image to be displayed in the first sub-guide area and a second base image to be displayed in the second sub-guide area, the at least one instruction, when executed by the at least one processor, may further cause the electronic device to determine the display area for allowing a weighted average of the first base image and the second base image to be greater than the preset threshold, the weighted average being calculated by using the first weight and the second weight, and a ratio of the second base image to the base image decreases as the preset threshold increases.

The input image may include at least one of content or a graphical user interface.

The hologram guide may include a plurality of reflection surfaces, the display area may include a plurality of display surfaces respectively corresponding to the plurality of reflection surfaces, and the at least one instruction, when executed by the at least one processor, may further cause the electronic device to: convert, based on the display area, the input image into a plurality of base images for allowing the holographic image to be implemented on a same side of respective front sides of the plurality of reflection surfaces, the holographic image being implemented via the hologram guide by reflecting the plurality of base images, and display the plurality of base images respectively on the plurality of display surfaces.

The hologram guide may include a plurality of reflection surfaces, the display area may include a plurality of display surfaces respectively corresponding to the plurality of reflection surfaces, and the at least one instruction, when executed by the at least one processor, may further cause the electronic device to: convert, based on the display area, the input image into a plurality of base images for allowing the holographic image to be implemented on different sides of respective front sides of the plurality of reflection surfaces, the holographic image being implemented via the hologram guide by reflecting the plurality of base images, and display the plurality of base images respectively on the plurality of display surfaces.

According to an aspect of the disclosure, an operating method of an electronic device, includes: obtaining an input image; obtaining information about a guide area of a display of the electronic device, the guide area including a plurality of sub-guide areas having a plurality of different weights with respect to implementation of a holographic image, the holographic image being implemented via a hologram guide by reflecting a base image based on the input image; determining a display area in the guide area, in which the base image can be displayed, based on the input image and the information about the guide area, the base image having a weight greater than a preset threshold; converting the input image into the base image based on the display area; and displaying the base image in the display area.

The operating method may further include: determining whether the display is connected to the hologram guide; based on determining that the display is connected to the hologram guide, displaying the base image in the display area on the display, and based on determining that the display is not connect to the hologram guide, displaying the input image on the display.

The operating method may further include: receiving information about the hologram guide from the hologram guide; and obtaining information about the guide area based on the information about the hologram guide, the information about the hologram guide may include at least one of a type of the hologram guide, a shape of the hologram guide, a number of at least one reflection surface of the hologram guide, an angle formed between the at least one reflection surface and the display, or a material of the at least one reflection surface.

The plurality of different weights may include a first weight, a second weight less than the first weight, and a third weight less than the second weight, the plurality of sub-guide areas may include a first sub-guide area having the first weight, a second sub-guide area having the second weight, and a third sub-guide area having the third weight, and a distance between the first sub-guide area and the second sub-guide area may be less than a distance between the first sub-guide area and the third sub-guide area.

In an embodiment, the operating method of the electronic device 100 may include receiving indication information including information about a target image among the input image, the target image to be implemented as the holographic image, from a server or a neighboring electronic device which provides the input image. In the determining of the display area (S300_1), the display area in which the base image for implementing the target image as the holographic image may be displayed may be determined, based on the input image, the information about the guide are, and the indication information. In the converting of the input image into the base image (S400_1), the input image may be converted into the base image, based on the determined display area and the indication information.

In an embodiment, the operating method of the electronic device 100 may include receiving tag information including information indicating that a portion of the input image is a main image. In the determining of the display area 705 (S300_2), the display area may be determined, based on the input image, the information about the guide area, and the tag information, so as to allow the base image for implementing the main image to be displayed in an area having a greatest weight among the plurality of sub-guide areas. In the converting of the input image 240 into the base image 250 (S400_2), the input image may be converted into the base image, based on the determined display area and the tag information.

In an embodiment, the plurality of different weights may include a first weight and a second weight less than the first weight. The plurality of sub-guide areas may include a first sub-guide area having the first weight and a second sub-guide area having the second weight. The base image may include a first base image to be displayed in the first sub-guide area and a second base image to be displayed in the second sub-guide area. In the determining of the display area (S300_3), the operating method may include determining the display area so as to allow a weighted average of the first base image and the second base image to be greater than a preset threshold, the weighted average being calculated by using the first weight and the second weight. A ratio of the second base image to the base image may decrease as the preset threshold increases.

In an embodiment, when the hologram guide (120) includes a plurality of reflection surfaces, the display area includes a plurality of display surfaces respectively corresponding to the plurality of reflection surfaces. In the converting of the input image into the base image (S400), the input image may be converted into a plurality of base images, based on the determined display area, so as to allow the holographic image to be implemented as a same side on respective front sides of the plurality of reflection surfaces, the holographic image being implemented by reflecting the plurality of base images. In the displaying of the base image in the display area (S500), the plurality of base images may be respectively displayed on the plurality of display surfaces.

According to an aspect of the disclosure, a non-transitory computer-readable storage medium has recorded thereon a program for performing the operating method.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram for describing an electronic device according to an embodiment of the present disclosure;

FIG. 2 is a diagram for describing an operation mode of an electronic device according to an embodiment of the present disclosure;

FIG. 3 is a block diagram for describing an electronic device according to an embodiment of the present disclosure;

FIG. 4 is a flowchart for describing an operation of an electronic device, according to an embodiment of the present disclosure;

FIG. 5 is a flowchart for describing an operation of an electronic device, according to an embodiment of the present disclosure;

FIG. 6 is a diagram for describing that connection between a display and a hologram guide is checked, according to an embodiment of the present disclosure;

FIG. 7 is a diagram for describing a hologram guide and a guide area, according to an embodiment of the present disclosure;

FIG. 8 is a diagram for describing a hologram guide and a guide area, according to an embodiment of the present disclosure;

FIG. 9 is a diagram for describing a hologram guide and a guide area, according to an embodiment of the present disclosure;

FIG. 10 is a flowchart for describing an operation of an electronic device, according to an embodiment of the present disclosure;

FIG. 11A is a diagram for describing a target image among content, the target image to be implemented as a holographic image, according to an embodiment of the present disclosure;

FIG. 11B is a diagram for describing a display area and a base image for implementing a target image as a holographic image, according to an embodiment of the present disclosure;

FIG. 12A is a diagram for describing a target image among a graphical user interface (GUI), the target image to be implemented as a holographic image, according to an embodiment of the present disclosure;

FIG. 12B is a diagram for describing a display area and a base image for implementing a target image as a holographic image, according to an embodiment of the present disclosure.

FIG. 13A is a diagram for describing a main image that is a portion of content, according to an embodiment of the present disclosure;

FIG. 13B is a diagram for describing a display area and a base image for displaying a main image in a first sub-guide area, according to an embodiment of the present disclosure;

FIG. 14A is a diagram for describing a main image that is a portion of a GUI, according to an embodiment of the present disclosure;

FIG. 14B is a diagram for describing a display area and a base image for displaying a main image in a first sub-guide area, according to an embodiment of the present disclosure;

FIG. 15 is a diagram for describing a display area and a base image determined so as to allow a weighted average of a first base image and a second base image of content to be greater than a preset threshold, according to an embodiment of the present disclosure;

FIG. 16A is a diagram for describing a GUI, according to an embodiment of the present disclosure;

FIG. 16B is a diagram for describing a display area and a base image determined so as to allow a weighted average of a first base image and a second base image of a GUI to be greater than a preset threshold, according to an embodiment of the present disclosure;

FIG. 17 is a diagram for describing that a plurality of base images are displayed in a display area, the plurality of base images being implemented as different sides of a holographic image on respective front sides of a plurality of reflection surfaces, according to an embodiment of the present disclosure; and

FIG. 18 is a diagram for describing that a plurality of base images are displayed in a display area, the plurality of base images being implemented as the same side of a holographic image on respective front sides of a plurality of reflection surfaces, according to an embodiment of the present disclosure.

### DETAILED DESCRIPTION

The terms used in the present disclosure will be briefly defined, and an embodiment of the present disclosure will be described in detail.

Although the terms used in the present disclosure are selected from among common terms that are currently widely used in consideration of their functions in an embodiment of the present disclosure, the terms may vary according the intention of one of ordinary skill in the art, a precedent, or the advent of new technology. Also, in particular cases, the terms are discretionally selected by the applicant, and the meaning of those terms will be described in detail in the corresponding part of the detailed description of an embodiment of the present disclosure. Therefore, the terms used in the present disclosure are not merely designations of the terms, but the terms are defined based on the meaning of the terms and content throughout the present disclosure.

As used herein, the singular forms may include the plural forms as well, unless the context clearly indicates otherwise. Unless otherwise defined, all terms including technical or scientific terms used herein may have the same meanings as commonly understood by one of ordinary skill in the art of the present disclosure.

Also, in the present disclosure, when a part “includes” or “comprises” an element, unless there is a particular description contrary thereto, the part can further include other elements, not excluding the other elements. Also, the terms such as “ . . . unit,” “module,” or the like used in the present disclosure indicate a unit, which processes at least one function or operation, and the unit may be implemented by hardware or software, or by a combination of hardware and software.

Throughout the disclosure, the expression “at least one of a, b or c” indicates only a, only b, only c, both a and b, both a and c, both b and c, all of a, b, and c, or variations thereof.

The expression “configured to (or set to)” used in the present disclosure may be replaced with, for example, “suitable for,” “having the capacity to,” “designed to,” “adapted to,” “made to,” or “capable of” according to cases. The expression “configured to (or set to)” may not necessarily mean “specifically designed to” in a hardware level. Instead, in some cases, the expression “system configured to . . . ” may mean that the system is “capable of . . . ” along with other devices or parts. For example, “a processor configured to (or set to) perform A, B, and C” may refer to a dedicated processor (e.g., an embedded processor) for performing a corresponding operation, or a general-purpose processor (e.g., a central processing unit (CPU) or an application processor (AP)) capable of performing a corresponding operation by executing one or more software programs stored in a memory.

Also, in the present disclosure, it should be understood that when elements are “connected” or “coupled” to each other, the elements may be directly connected or coupled to each other, but may alternatively be connected or coupled to each other with an element therebetween, unless specified otherwise.

Hereinafter, an embodiment of the present disclosure will be described in detail with reference to the accompanying drawings to allow one of skill in the art to easily implement the embodiment. However, the present disclosure may be embodied in many different forms and should not be construed as being limited to an embodiment set forth herein. In addition, in the drawings, parts irrelevant to the description are omitted to clearly describe an embodiment of the present disclosure, and like elements are denoted by like reference numerals throughout the present disclosure.

Hereinafter, embodiments of the present disclosure will be described in detail with reference to the drawings.

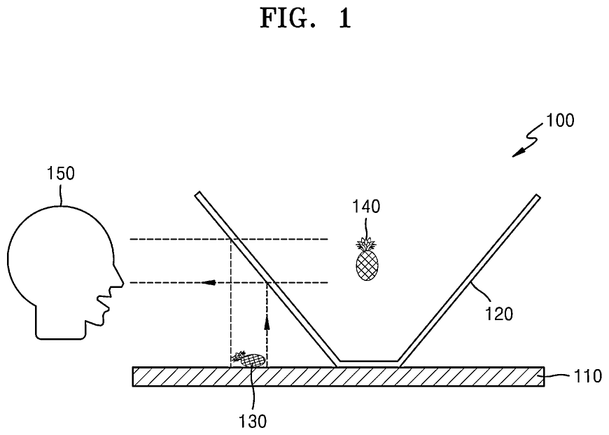

FIG. 1 is a diagram for describing an electronic device according to an embodiment of the present disclosure.

Referring to FIG. 1, an electronic device 100 according to an embodiment of the present disclosure may include a display 110.

In an embodiment, the display 110 is device for displaying an image, and may be implemented as various forms of a display such as a television (TV), a mobile device, a smart phone, a laptop computer, a desk top computer, a tablet personal computer (PC), an electronic-book terminal, a terminal for digital broadcasting, a personal digital assistant (PDA), a portable multimedia player (PMP), and the like.

In an embodiment, a hologram guide 120 may be provided on the display 110. In an embodiment, the hologram guide 120 may include at least one reflection surface for reflecting an image displayed on the display 110. The at least one reflection surface may include a translucent reflection surface.

In an embodiment, the hologram guide 120 provided on the display 110 may reflect the image displayed on the display 110, thereby providing the reflected image to a user 150. The hologram guide 120 may provide, to the user 150, a holographic image 140 implemented by reflecting the image displayed on the display 110.

In an embodiment, an image used to be implemented as the holographic image 140, the image being reflected by the hologram guide 120 and being among the image displayed on the display 110, may be referred to as a base image 130. The base image 130 displayed on the display 110 may be provided, to the user 150, as the holographic image 140 implemented by being reflected by the hologram guide 120. The user 150 may recognize that the holographic image 140 is implemented, by viewing the reflected base image 130 provided by the hologram guide 120 including the translucent reflection surface.

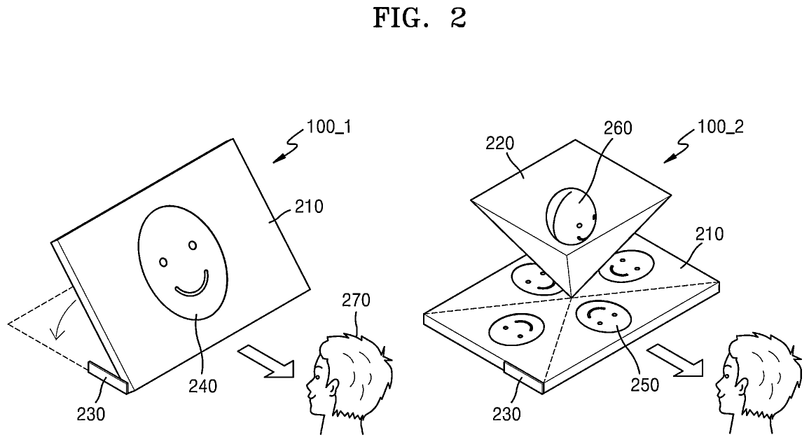

FIG. 2 is a diagram for describing an operation mode of an electronic device according to an embodiment of the present disclosure.

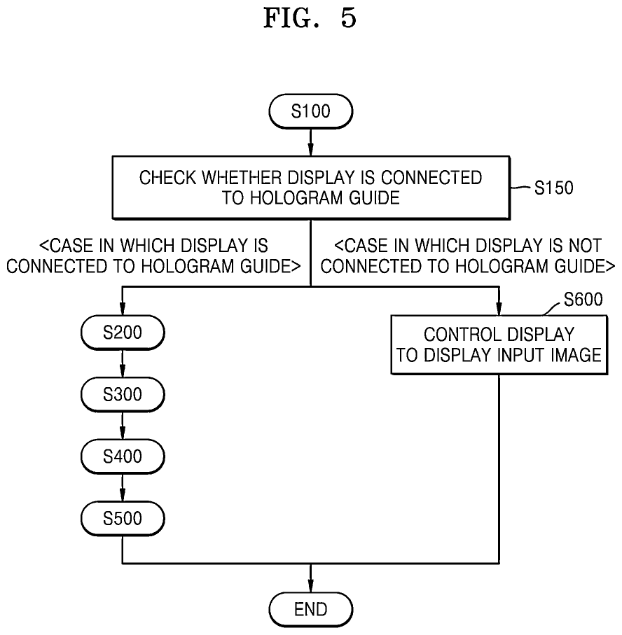

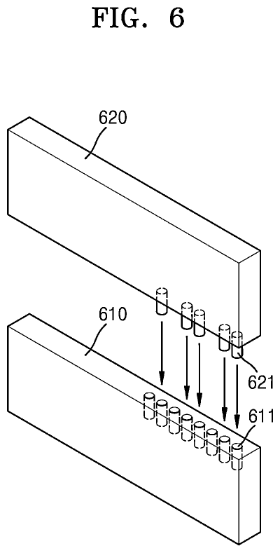

Referring to FIG. 2, an electronic device 100_1 or 100_2 may differently operate according to whether a display 210 is connected to a hologram guide 220. Hereinafter, connection between the display 210 and the hologram guide 220 will be described in detail with reference to FIGS. 5 and 6. In an embodiment, an electronic device of a case in which the display 210 is not connected to the hologram guide 220 is referred to as the first electronic device 100_1. An electronic device of a case in which the display 210 is connected to the hologram guide 220 is referred to as the second electronic device 100_2.

In an embodiment, the first electronic device 100_1 shown in FIG. 2 is the electronic device 100_1 of a case in which the electronic device 100 shown in FIG. 1 controls the display 210 to display an input image 240 when the display 210 is not connected to the hologram guide 220. When the display 210 is not connected to the hologram guide 220, the first electronic device 100_1 may control the display 210 to display the input image 240. The input image 240 may be an image generated based on image data provided to the first electronic device 100_1 to provide content or a graphical user interface (GUI) to a user 270 via the display 210.

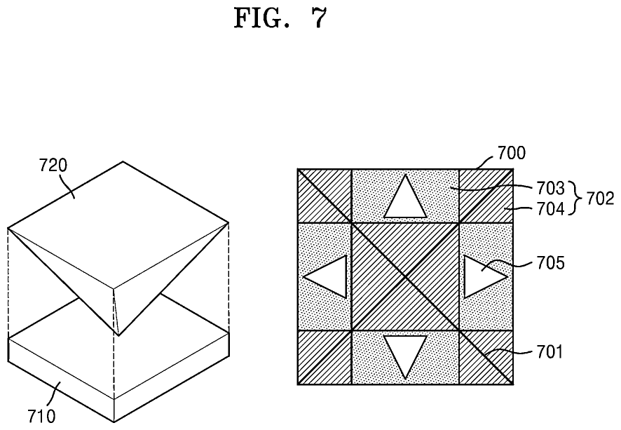

In an embodiment, the second electronic device 100_2 shown in FIG. 2 is the electronic device 100_2 of a case in which the electronic device 100 shown in FIG. 1 controls the display 210 to display a base image 250 in a display area 705 (see FIG. 7) when the display 210 is connected to the hologram guide 220. When the display 210 is connected to the hologram guide 220, the second electronic device 100_2 may control the display 210 to display the base image 250 in the display area 705 (see FIG. 7). The second electronic device 100_2 may control the display 210 to display the base image 250 in the display area 705 so as to provide the user 270 with a holographic image 260 implemented by the hologram guide 220.

In an embodiment, the display area 705 may be an area of the display 210, in which a base image reflected by the hologram guide 220 can be displayed. The base image 250 may be an image for implementing the desired holographic image 260 via the hologram guide 220. The electronic device 100_2 may obtain the base image 250 by converting the input image 240, and may control the display 210 to display the base image 250 in the display area 705. Hereinafter, the display area 705 and the base image 250 will be described in detail with reference to FIGS. 7 to 16B.

In an embodiment, the first electronic device 100_1 may include an angle adjuster 230 configured to adjust an angle between the display 210 and a surface in which the display 210 is disposed. In an embodiment, the angle adjuster 230 may include a hinge, a spring, a gear, or the like. However, the present disclosure is not limited thereto.

In an embodiment, when the first electronic device 100_1 provides the input image 240 to the user 270 via the display 210, the angle between the display 210 and the surface in which the display 210 is disposed may be adjusted to allow a front surface of the display 210 to face the user 270, for visibility of the user 270. When the first electronic device 100_1 provides the input image 240, the first electronic device 100_1 may control the angle adjuster 230 to adjust the angle between the display 210 and the surface in which the display 210 is disposed, in order to allow the front surface of the display 210 to face the user 270.

In an embodiment, when the holographic image 260 implemented by the hologram guide 220 is provided to the user 270, the second electronic device 100_2 may adjust an angle between a front surface of the display 210 and a surface in which the display 210 is disposed, for visibility of the user 270. The second electronic device 100_2 may control the angle adjuster 230 to adjust an angle between the display 210 and the surface in which the display 210 is disposed, in order to allow the holographic image 260 implemented by the hologram guide 220 to be provided to the front of the user.

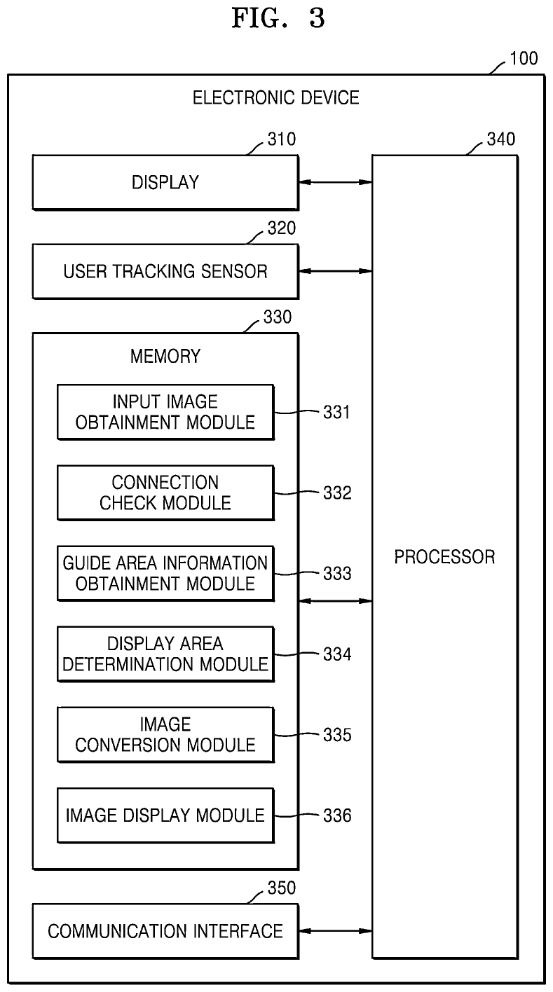

FIG. 3 is a block diagram for describing an electronic device according to an embodiment of the present disclosure. Hereinafter, descriptions of same configurations as configurations described with reference to FIGS. 1 and 2 are omitted here.

Referring to FIG. 3, the electronic device 100 may include a display 310, a user tracking sensor 320, memory 330, at least one processor 340, and a communication interface 350. However, not all elements shown in FIG. 3 are necessary elements. The electronic device 100 may be embodied with more elements than the elements shown in FIG. 3 or may be embodied with fewer elements than the shown elements.

In an embodiment, the display 310, the user tracking sensor 320, the memory 330, the at least one processor 340, and the communication interface 350 may be electrically and/or physically connected to each other.

In an embodiment, the display 310 may include any one display from among a liquid crystal display, a plasma display, an organic light emitting diode display, or an inorganic light emitting diode display. However, the present disclosure is not limited thereto, and the display 310 may include different types of a display capable of displaying an image.

In an embodiment, the user tracking sensor 320 may track a position, a gaze direction, etc. of the user 270 (see FIG. 2). The user tracking sensor 320 may detect an image of a pupil or iris of the user 270, thereby tracking the gaze direction of the user, a head position of the user, etc. The user tracking sensor 320 may track a position of the user 270 by using a red, green, blue (“RGB”) camera, an RGB-depth camera, or an infrared (IR) camera.

In an embodiment of the present disclosure, the memory 330 may include at least one of a flash memory-type memory, a hard disk-type memory, a multimedia card micro-type memory, a card-type memory (e.g., secure digital (SD) or extreme digital (XD) memory), a random access memory (RAM), a static random access memory (SRAM), a read-only memory (ROM), an electrically erasable programmable read-only memory (EEPROM), a programmable read-only memory (PROM), a mask ROM, flash ROM, a hard disk drive (HDD), or a solid state drive (SSD). The memory 330 may have stored therein at least one instruction or program code for performing functions or operations of the electronic device 100. The at least one instruction, an algorithm, the data structure, the program code, and an application program which are stored in the memory 330 may be implemented in, for example, programming or scripting languages such as C, C++, Java, assembler, etc.

In an embodiment, the memory 330 may have stored therein an input image obtainment module 331, a connection check module 332, a guide area information obtainment module 333, a display area determination module 334, an image conversion module 335, and an image display module 336. However, not all modules shown in FIG. 3 are necessary modules. The memory 330 may have stored therein more modules than the modules shown in FIG. 3 or may have stored therein fewer modules than the shown modules.

A ‘module’ included in the memory 330 may indicate a unit for processing a function or an operation performed by the at least one processor 340. The ‘module’ included in the memory 330 may be implemented as software such as at least one instruction, an algorithm, a data structure, or program code.

In an embodiment, the input image obtainment module 331 may include instructions or program code related to an operation or a function of obtaining the input image 240 to be displayed on the display 310. In an embodiment, the at least one processor 340 may execute the instructions or the program code of the input image obtainment module 331 to obtain the input image 240 to be provided to the user 270 (see FIG. 2) via the display 310.

In an embodiment, the connection check module 332 may include instructions or program code related to an operation or a function of checking whether the display 310 and the hologram guide 220 (see FIG. 2) are connected to each other. In an embodiment, the at least one processor 340 may execute the instructions or the program code of the connection check module 332 to check whether the display 310 and the hologram guide 220 are connected to each other. Hereinafter, whether the display 310 and the hologram guide 220 are connected to each other is checked via the instructions or the program code included in the connection check module will be described in detail with reference to FIGS. 5 and 6.

In an embodiment, the guide area information obtainment module 333 may include instructions or program code related to an operation or a function of obtaining information about a guide area 700 (see FIG. 7) including a plurality of sub-guide areas having different weights with respect to implementation of the holographic image 260 (see FIG. 2) via the hologram guide 220. In an embodiment, the at least one processor 340 may execute the instructions or the program code of the guide area information obtainment module 333 to obtain the information about the guide area 700 (see FIG. 7) including the plurality of sub-guide areas having the different weights.

In an embodiment, the at least one processor 340 may execute the instructions or the program code of the guide area information obtainment module 333 to receive information about the hologram guide 220 from the hologram guide 220. The information about the hologram guide 220 may include at least one piece of information among a type and shape of the hologram guide, the number of at least one reflection surface included in the hologram guide, an angle formed between the at least one reflection surface and a display, or a material of the at least one reflection surface. The at least one processor 340 may execute the instructions or the program code of the guide area information obtainment module 333 to obtain the information about the guide area, based on the received information about the hologram guide. Hereinafter, the information about the hologram guide will be described in detail with reference to FIGS. 7 to 9.

In an embodiment, the display area determination module 334 may include instructions or program code related to an operation or a function of determining the display area 705 of the guide area 700, in which the base image 250 (see FIG. 2) is displayed, based on the input image 240 (FIG. 2) and the information about the guide area 700. The display area determination module 334 may include instructions or program code related to an operation or a function of determining, in the guide area 700, the display area 705 in which the base image 250 having a weight greater than a preset threshold can be displayed, based on the input image 240 and the information about the guide area 700.

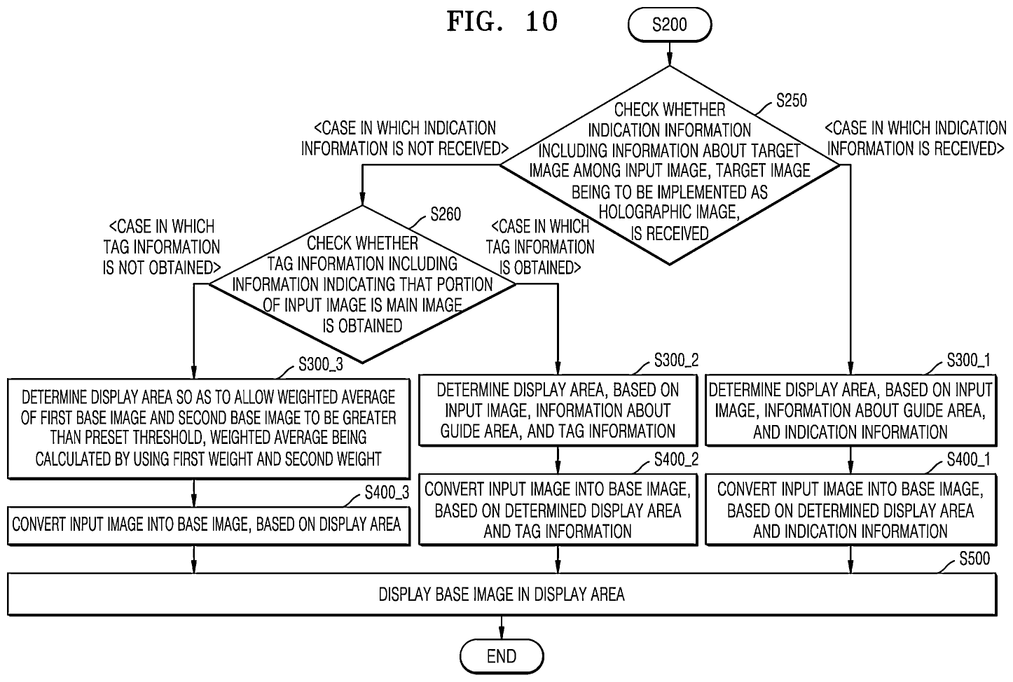

The at least one processor 340 may execute the instructions or the program code of the display area determination module 334 to determine, in the guide area 700, the display area 705 in which the base image 250 is displayed, based on the input image 240 and the information about the guide area 700. The at least one processor 340 may execute the instructions or the program code of the display area determination module 334 to determine, in the guide area 700, the display area 705 in which the base image 250 having the weight greater than the preset threshold can be displayed, based on the input image 240 and the information about the guide area 700. Hereinafter, the preset threshold and the display area 705 will be described in detail with reference to FIGS. 10 to 16B.

In an embodiment, the image conversion module 335 may include instructions or program code related to an operation or a function of converting the input image 240 into the base image 250 to be displayed in the display area 705, based on the determined display area 705. The image conversion module 335 may include the instructions or the program code related to an operation or a function of converting the input image 240 into the base image 250 via at least one operation among resizing, cropping, rotating, or overlaying the input image 240, so as to display the input image 240 in the display area 705. However, the present disclosure is not limited thereto, and the image conversion module 335 may include instructions or program code related to another image conversion operation or function which may be performed to convert the input image 240 into the base image 250.

In an embodiment, the at least one processor 340 may execute the instructions or the program code of the image conversion module 335 to convert the input image 240 into the base image 250, based on the determined display area 705. Hereinafter, conversion of the input image 240 into the base image 250 will be described in detail with reference to FIGS. 10 to 16B.

In an embodiment, the at least one processor 340 may be configured as at least one of a central processing unit, a microprocessor, a graphics processing unit, an application processor (AP), application specific integrated circuits (ASICs), digital signal processors (DSPs), digital signal processing devices (DSPDs), programmable logic devices (PLDs), field programmable gate arrays (FPGAs), a neural processing unit, or an artificial intelligence (AI)-dedicated processor having a hardware structure specialized for training and processing of an AI model, but the present disclosure is not limited thereto.

In an embodiment, the at least one processor 340 may execute the at least one instruction stored in the memory 330 to control the electronic device 100 to perform an operation of the present disclosure.

In an embodiment, the communication interface 350 may perform data communication with an external server or neighboring electronic devices, under the control of the at least one processor 340. Also, the communication interface 350 may perform data communication with the hologram guide 220.

In an embodiment, the communication interface 350 may perform data communication with a server or neighboring electronic devices by using at least one of data communication schemes including wired local area network (LAN), wireless LAN, Wi-Fi, Bluetooth, ZigBee, Wi-Fi direct (WFD), infrared data association (IrDA), Bluetooth low energy (BLE), Near Field Communication (NFC), wireless broadband Internet (WiBro), World interoperability for microwave access (WiMAX), shared wireless access protocol (SWAP), wireless gigabit alliance (WiGig), and radio frequency (RF) communication.

In an embodiment, the communication interface 350 may receive the input image 240 from at least one of the server or a neighboring electronic device. The at least one processor 340 may control the display 210 to display the received input image 240, or may control the display 210 to convert the input image 240 into the base image 250 and display the base image 250 in the display area 705.

In an embodiment, the communication interface 350 may receive, from the hologram guide 220, a connection signal including information indicating connection to the display 210. When the at least one processor 340 receives the connection signal via the communication interface 350, the at least one processor 340 may control the display 210 to display the base image 250 in the display area.

In an embodiment, when the at least one processor 340 does not receive the connection signal via the communication interface 350, the at least one processor 340 may control the display 210 to display the input image 240. However, the present disclosure is not limited thereto, and even when the connection signal is not received via the communication interface 350, the at least one processor 340 may control the display 210 to display the base image 250 in the display area, based on connection between the display 210 and the hologram guide 220 being checked.

In an embodiment, the communication interface 350 may receive the information about the hologram guide 220 from the hologram guide 220, under the control of the at least one processor 340. The information about the hologram guide 220 may include at least one information among a type of a hologram guide, a shape of the hologram guide, the number of at least one reflection surface included in the hologram guide, an angle formed between the at least one reflection surface and a display, or a material of the at least one reflection surface.

In an embodiment, the at least one processor 340 may obtain the information about the guide area 700, as a result of calculation based on the received information about the hologram guide 220.

In an embodiment, under the control of the at least one processor 340, the communication interface 350 may receive the information about the hologram guide 220 from the hologram guide 220 and the information about the guide area 700. The at least one processor 340 may determine the display area 705, based on the received information about the guide area 700, and may convert the input image 240 into the base image 250.

In an embodiment, under the control of the at least one processor 340, the communication interface 350 may transmit the information about the hologram guide 220 to at least one of a server or a neighing electronic device, and may receive information about the guide area 700 which corresponds to the transmitted information about the hologram guide 220, from at least one of the server or the neighing electronic device.

Hereinafter, for convenience of descriptions, it is described that the information about the guide area 700 is obtained as a result of calculation based on the information about the hologram guide 220 which is received from the hologram guide 220 to the at least one processor 340.

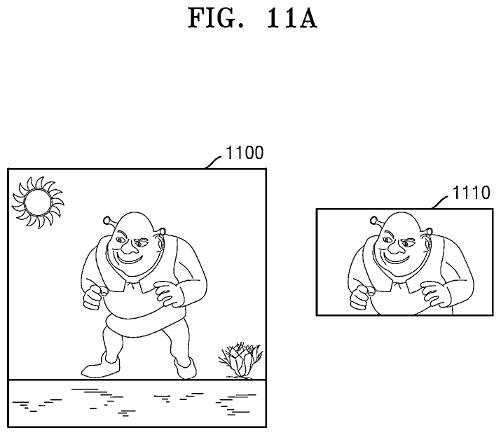

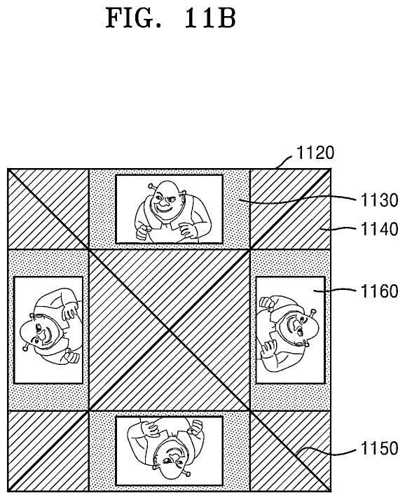

In an embodiment, under the control of the at least one processor 340, the communication interface 350 may receive indication information including information about a target image 1110 (see FIG. 11A) among a provided input image 1100 (see FIG. 11A), the target image 1110 to be implemented as the holographic image 260, from the server or the neighing electronic device providing the input image 240.

Based on the input image 1100, the information about the guide area 700, and the indication information, the at least one processor 340 may determine a display area in which a base image 1160 for implementing the target image 1110 as the holographic image 260 can be displayed, and may control the display 210 to display the base image 1160 in the determined display area. Hereinafter, an operation of the electronic device 100 in a case of receiving the indication information including information about the target image 1110 will be described in detail with reference to FIGS. 1 to 12B.

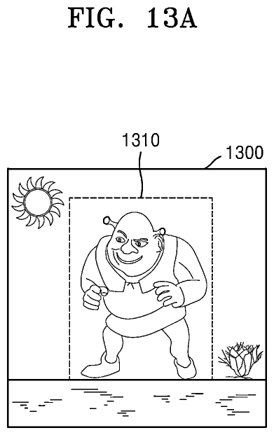

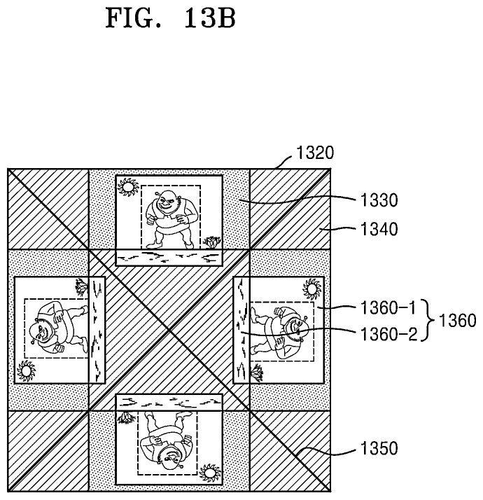

In an embodiment, under the control of the at least one processor 340, the communication interface 350 may receive tag information including information indicating that a portion of a provided input image 1300 (see FIG. 13A) is a main image 1310, from the server or the neighing electronic device providing the input image 240.

Based on the input image 1300, the information about the guide area 700, and the tag information, the at least one processor 340 may determine a display area such that the main image 1310 may be displayed in an area having a greatest weight from among a plurality of guide areas, and may display the base image 1360 in the determined display area. Hereinafter, an operation of the electronic device 100 in a case of receiving tag information including information about a main image will be described in detail with reference to FIGS. 10 and 13A to 14B.

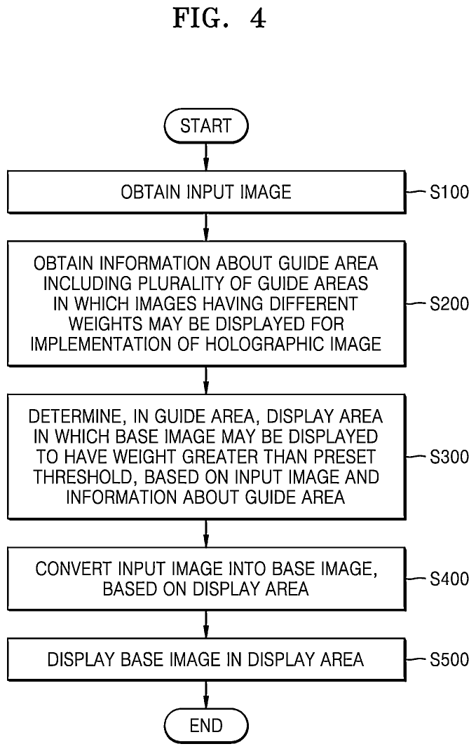

FIG. 4 is a flowchart for describing an operation of an electronic device, according to an embodiment of the present disclosure.

Referring to FIGS. 2, 3, and 4, in an embodiment, an operating method of the electronic device 100 may include obtaining the input image 240 (S100). In the obtaining of the input image 240 (S100), the at least one processor 340 may obtain the input image 240 via the communication interface 350.

In an embodiment, the operating method of the electronic device 100 may include obtaining information about the guide area 700 (see FIG. 7) including a plurality of sub-guide areas in which images having different weights in implementation of the holographic image 260 may be displayed, so as to allow the holographic image 260 to be provided by the hologram guide 220, the holographic image 260 being implemented by reflecting the base image 250 based on the input image 240 (S200).

In an embodiment, in the obtaining of the information about the guide area 700 (S200), the at least one processor 340 may obtain information about the hologram guide 220 from the hologram guide 220 via the communication interface 350, and may obtain the information about the guide area 700, based on the obtained information about the hologram guide 220. In an embodiment, in the obtaining of the information about the guide area 700 (S200), the at least one processor 340 may obtain the information about the hologram guide 220 from the hologram guide 220 and the information about the guide area 700 via the communication interface 350.

Hereinafter, the guide area 700 will be described in detail with reference to FIGS. 7 to 9.

In an embodiment, the operating method of the electronic device 100 may include determining, in the guide area 700, the display area 705 (see FIG. 7) in which the base image 250 may be displayed to have a weight greater than a preset threshold, based on the input image 240 and the information about the guide area 700 (S300).

In an embodiment, in the determining of the display area 705 (S300), the at least one processor 340 may determine the display area 705 of the guide area 700, in which the base image 1160 can be displayed to have a weight greater than a preset threshold, based on content included in the input image 240 or content of a GUI and areas, shapes, arrangements, etc. of the plurality of sub-guide areas having different weights which are included in the information about the guide area 700.

In an embodiment, the operating method of the electronic device 100 may include converting the input image 240 into the base image 250, based on the display area 705 (S400).

In an embodiment, in the converting of the input image 240 into the base image 250 (S400), the at least one processor 340 may convert the input image 240 into the base image 250 by resizing, cropping, rotating, or overlaying the input image 240, so as to display the base image 250 in the display area 705.

In an embodiment, the operating method of the electronic device 100 may include displaying the converted base image 250 in the display area 705 (S500).

In an embodiment, the electronic device 100 may control the display 110 to display the base image 250 in the display area 705, thereby allowing the holographic image 260 implemented by the hologram guide 220 to be provided to the user 270.

FIG. 5 is a flowchart for describing an operation of an electronic device, according to an embodiment of the present disclosure. FIG. 6 is a diagram for describing that connection between a display and a hologram guide is checked, according to an embodiment of the present disclosure. Hereinafter, descriptions of same operations as the operations described with reference to FIG. 4 are omitted.

Referring to FIGS. 2, 5, and 6, in an embodiment, the operating method of the electronic device 100 may further include determining whether the display 210 is connected to the hologram guide 220 (S150).

In an embodiment, FIG. 6 illustrates a portion 610 of a display and a portion 620 of a hologram guide. The electronic device 100 may determine whether the display 210 is connected to the hologram guide 220, by using at least one first sensor 611 included in the portion 610 of the display and at least one second sensor 621 included in the portion 620 of the hologram guide. Each of the at least one first sensor 611 may include a light-receiving diode, and each of the at least one second sensor 621 may include a light-emitting diode. However, the present disclosure is not limited thereto, and the at least one first sensor 611 may include a light-emitting diode, and the at least one second sensor 621 may include a light-receiving diode.

In an embodiment, the at least one first sensor 611 may have a shape that is concave inward the portion 610 of the display. The at least one second sensor 621 may have a shape that is convex outward the portion 620 of the hologram guide. The at least one first sensor 611 having the concave shape and the at least one second sensor 621 having the convex shape may be combined in an up-and-down direction. However, the present disclosure is not limited thereto, and unlike the illustration of FIG. 6, the at least one first sensor 611 and the at least one second sensor 621 may be combined in a right-and-left direction. In an embodiment, the at least one first sensor 611 having the concave shape and the at least one second sensor 621 having the convex shape may be combined to each other, such that it is possible to prevent that the display 210 and the hologram guide 220 are moved while being connected to each other.

In an embodiment, when the display 210 is connected to the hologram guide 220, outputs of light-receiving diodes respectively included in the at least one first sensor 611 included in the portion 610 of the display may vary. When the number or arrangement of at least one second sensor 621 included in the portion 620 of the hologram guide varies according to types of the hologram guide, outputs of light-receiving diodes respectively included in the at least one first sensor 611 included in the portion 610 of the display may vary according to the types of the hologram guide.

Therefore, the at least one processor 340 may determine whether the display 210 is connected to the hologram guide 220, and a type of the hologram guide 220, based on outputs of the light-receiving diodes respectively included in the at least one first sensor 611 included in the portion 610 of the display.

However, the present disclosure is not limited thereto. The first sensor 611 and the second sensor 621 are flat and have shapes corresponding to each other, and when the display 210 is connected to the hologram guide 220, it is possible to check whether the display 210 is connected to the hologram guide 220, and a type of the hologram guide 220, by using that outputs of the light-receiving diodes respectively included in the at least one first sensor 611 vary.

Also, the electronic device 100 may sense an external input such as a user touch, an electronic pen, a contact, a pressure, or the like which is provided outside the electronic device 100, and may further include a touch sensing panel provided on the display 210. The at least one processor 340 may determine, via the touch sensing panel, whether the display 210 is connected to the hologram guide 220, such that the hologram guide 220 may be provided on the touch sensing panel provided on the display 210 and may reflect a base image displayed on the display 210.

Also, in an embodiment, the electronic device 100 may detect an external input provided to the display 210 via an infrared (IR) sensor. In an embodiment, the electronic device 100 may further include the IR sensor provided on a bezel portion of the display 210. The at least one processor 340 may check, via the IR sensor, whether the display 210 is connected to the hologram guide 220, such that the hologram guide 220 may be provided on the display 210 and may reflect a base image displayed on the display 210.

In an embodiment, the operating method of the electronic device 100 may further include receiving information about the hologram guide from the hologram guide 220, based on connection between the display 210 and the hologram guide 220 being determined.

In an embodiment, when the portion 610 of the display includes a plurality of first sensors, and the portion 620 of the hologram guide includes a plurality of second sensors, the at least one processor 340 determine whether the display 210 is connected to the hologram guide 220, a type of the hologram guide 220, and the information about the hologram guide, based on outputs of light-receiving diodes respectively included in the plurality of first sensors.

In an embodiment, when the display 210 and the hologram guide 220 each include a radio-frequency identification (RFID) chip, the at least one processor 340 may receive the information about the hologram guide via the RFID chip included in the hologram guide 220.

In an embodiment, the information about the hologram guide may include at least one of a type of the hologram guide, a shape of the hologram guide, the number of at least one reflection surface included in the hologram guide, an angle formed between the at least one reflection surface and a display, or a material of the at least one reflection surface.

In an embodiment, based on connection between the display 210 and the hologram guide 220 being determined, the at least one processor 340 may obtain information about a guide area (S200), may determine a display area among the guide area (S300), may convert an input image into a base image (S400), and may control the display 210 to display the base image 250 in the display area 705 (S500).

In an embodiment, in the checking of whether the display 210 is connected to the hologram guide 220 (S150), when it is determined that the display 210 is not connected to the hologram guide 220, the operating method of the electronic device 100 may include controlling the display 210 to display the input image 240 (S600).

In an embodiment, when it is determined that the hologram guide 220 is not connected, the at least one processor 340 may control the display 210 to display the input image 240, thereby providing the input image 240 to the user 270.

Hereinafter, for convenience of descriptions, it is described that the display 210 is connected to the hologram guide 220, and the at least one processor 340 controls the display 210 to display the base image 250 in the display area 705.

FIG. 7 is a diagram for describing a hologram guide and a guide area, according to an embodiment of the present disclosure. Hereinafter, descriptions of same configurations as configurations described with reference to FIGS. 1 and 2 are omitted here.

Referring to FIGS. 2 and 7, a display 710 and a hologram guide 720 provided on the display 710 are shown.

In an embodiment, it is shown that the hologram guide 720 has an inverted pyramid shape, a part corresponding to an apex of the inverted pyramid shape is provided on the display 710, and the hologram guide 720 has a total of four reflection surfaces.

In an embodiment, FIG. 7 illustrates that a size of the display 710 corresponds to a size of the hologram guide 720, but the present disclosure is not limited thereto. For example, a size of a display may be greater than a size of a hologram guide, and the hologram guide may have the size corresponding to a portion of the display.

In an embodiment, the at least one processor 340 (see FIG. 3) may obtain, from the hologram guide 720, information about the hologram guide 720 which includes at least one piece of information among information indicating that a type of the hologram guide 720 is an inverted pyramid shape, a shape of the hologram guide 720, information indicating that the hologram guide 720 has four reflection surfaces, angles formed between respective reflection surfaces and the display 710, or a material of each reflection surface.

In an embodiment, the at least one processor 340 may include information about a guide area 700 based on the obtained information about the hologram guide 720. Here, the guide area 700 may indicate an area of the display 710, in which an image that can be reflected by the hologram guide 720 and can implemented as the holographic image 260 may be displayed. That is, an image displayed in the guide area 700 may be reflected by the hologram guide 720 and implemented as the holographic image 260. On the other hand, an image displayed in an area outside the guide area 700 may not be reflected by the hologram guide 720.

In an embodiment, based on the information about the hologram guide 720, the at least one processor 340 may obtain information indicating that the guide area 700 includes four divided guide areas which are classified by segmentation lines 701. In this regard, the four divided guide areas are areas capable of displaying images that may be reflected by four corresponding reflection surfaces, respectively.

In an embodiment, the at least one processor 340 may obtain information indicating that each of the four divided guide areas has a plurality of sub-guide areas 702 having different weights, based on the information about the hologram guide 720. In an embodiment, the plurality of sub-guide areas 702 may include a first sub-guide area 703 having a first weight and a second sub-guide area 704 having a second weight less than the first weight.

Here, based on the information about the hologram guide 720, a weight may be determined according to a quality of the holographic image 260 that is an image displayed in the guide area 700 and implemented by being reflected by the hologram guide 720. For example, a weight of an area in the guide area 700, the area being capable of displaying a high quality image of the holographic image 260 implemented by being reflected by the hologram guide 720, may be set to be high. A weight of an area in the guide area 700, the area being capable of displaying a low quality image of the holographic image 260 implemented by being reflected by the hologram guide 720, may be set to be low.

In an embodiment, the quality of the holographic image 260 may be measured according to at least one of an image quality, brightness, resolution, a depth, a grayscale, or a viewing angle of the holographic image 260. Based on the obtained information about the hologram guide 720, the at least one processor 340 may simulate the quality of the holographic image 260 implemented by the hologram guide 720 and recognized by the user 270, and then may divide the guide area 700 into the plurality of sub-guide areas 702 having different weights and may obtain the information about the guide area 700.

In an embodiment, the at least one processor 340 may define a weight greater than a preset weight as a first weight, and may classify an area in the guide area 700, the area having a weight greater than the preset weight, as the first sub-guide area 703. The at least one processor 340 may define a weight equal to or less than the preset weight as a second weight, and may classify an area in the guide area 700, the area having a weight equal to or less than the preset weight, as the second sub-guide area 704.

Here, a size of the preset weight may be determined based on a quality of the holographic image 260 that is implemented by the hologram guide 720 and is to be provided to the user 270. When the quality of the holographic image 260 to be provided to the user 270 increases, the preset weight may increase, and an area of the first sub-guide area 703 may decrease.

In an embodiment, a value of the preset weight may be provided from the hologram guide 720 or may be set by reflecting the quality of the holographic image 260 to be provided to the user 270 by the at least one processor 340.

In an embodiment, when a weight for distinguishing between a first weight and a second weight is a first preset weight, the at least one processor 340 may define a weight greater than the first preset weight as the first weight, and may classify an area in the guide area 700, the area having a weight greater than the first preset weight, as the first sub-guide area 703. The at least one processor 340 may define a weight being equal to or less than the first preset weight and being greater than a second preset weight less than the first preset weight, as a second weight, and may classify an area in the guide area 700, the area having the second weight, as the second sub-guide area. The at least one processor 340 may define a weight equal to or less than the second preset weight, as a third weight, and may classify an area in the guide area 700, the area having the third weight, as a third sub-guide area.

In an embodiment, a distance between the first sub-guide area 703 and the second sub-guide area 704 may be smaller than a distance between the first sub-guide area 703 and the third sub-guide area. When a distance to an area of the guide area 700 increases from the first sub-guide area 703 capable of displaying a high quality image of the holographic image 260 implemented by being reflected by the hologram guide 720, a quality of an image of the holographic image 260 implemented by being reflected by the hologram guide 720, the image being displayed in the area, may decrease. Accordingly, when an amount of information included in the holographic image 260 is increased by decreasing a size of a threshold to be described below, the base image 250 may be displayed in sequential order from an area close to the first sub-guide area 703 to an area distant from the first sub-guide area 703.

Hereinafter, for convenience of descriptions, it is described that the guide area 700 includes the first sub-guide area 703 having the first weight and the second sub-guide area 704 having the second weight.

In an embodiment, the first sub-guide area 703 may be classified as a center area that does not correspond to a corner from among each of divided guide areas having a triangular shape. In an embodiment, the second sub-guide area 704 may be classified as a corner area corresponding to the corner from among each of the divided guide areas. A gaze direction of the user 270 who views the holographic image 260 may correspond to at least an intermediate area in each reflection surface. A holographic image provided to an area corresponding to a corner of each reflection surface does not correspond to an area to which the gaze direction of the user 270 reaches, and thus, an area corresponding to the area may be classified as the second sub-guide area 704.

However, the present disclosure is not limited thereto, and sizes and arrangements of the first sub-guide area 703 and the second sub-guide area 704 included in the guide area 700 may vary according to a shape of the hologram guide 720, an angle formed between a reflection surface of the hologram guide 720 and the display 710, a position, a gaze direction, an eye level, etc. of the user 270 who receives the holographic image 260.

In an embodiment, based on the input image 240 and the information about the guide area 700, the at least one processor 340 may determine, in the guide area 700, the display area 705 in which the base image 250 may be displayed with a weight greater than a preset threshold. Hereinafter, determining of the display area 705 will be described with reference to FIGS. 11 to 16B.

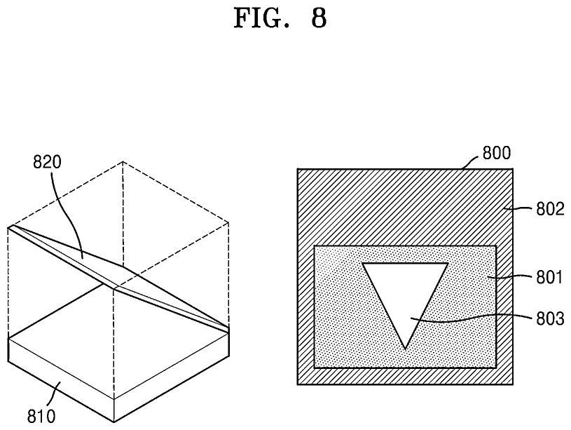

FIG. 8 is a diagram for describing a hologram guide and a guide area, according to an embodiment of the present disclosure. Hereinafter, descriptions of same configurations as configurations described with reference to FIG. 7 are omitted here.

Referring to FIGS. 2 and 8, in an embodiment, a hologram guide 820 having a flat-surface shape and obliquely provided on a display 810 is shown. It is shown that one side among four sides of the hologram guide 820 is provided on the display 810, and the hologram guide 820 has one reflection surface.

In an embodiment, the at least one processor 340 (see FIG. 3) may obtain, from the hologram guide 820, information about the hologram guide 820, the information including at least one piece of information among information indicating that a type of the hologram guide 820 is a plane, information indicating that the hologram guide 820 has a shape obliquely provided on the display 810, information indicating that the hologram guide 820 includes one reflection surface, an angle formed between the one reflection surface and the display 810, or a material of the one reflection surface.

In an embodiment, the at least one processor 340 may obtain information about a guide area 800, based on the obtained information about the hologram guide 820.

In an embodiment, the at least one processor 340 may obtain information indicating that the guide area 800 includes a plurality of sub-guide areas having different weights, based on the information about the hologram guide 820. In an embodiment, the plurality of sub-guide areas may include a first sub-guide area 801 having a first weight and a second sub-guide area 802 having a second weight smaller than the first weight.

An eye level of the user 270 who views the holographic image 260 may correspond to at least an intermediate height of a height of the reflection surface. As a holographic image provided on an area of the reflection surface, the area being adjacent to a side at which the display 810 contacts the hologram guide 820, is different from the eye level of the user 270, a guide area corresponding to the area may be classified as the second sub-guide area 802.

In an embodiment, a guide area corresponding to a reflection surface providing a holographic image corresponding to the eye level of the user 270 may be classified as the first sub-guide area 801. In an embodiment, a distance between the first sub-guide area 801 and the side at which the display 810 contacts the hologram guide 820 may be greater than a distance between the first sub-guide area 801 and a side opposite to the side at which the display 810 contacts the hologram guide 820.

However, the present disclosure is not limited thereto, and sizes and arrangements of the first sub-guide area 801 and the second sub-guide area 802 which are included in the guide area 800 may vary, according to a shape of the hologram guide 820, an angle formed between the reflection surface of the hologram guide 820 and the display 810, a position and the eye level of the user 270 who receives the holographic image 260, or the like.

In an embodiment, the at least one processor 340 may determine, in the guide area 800, a display area 803 in which the base image 250 may be displayed with a weight greater than the preset threshold.

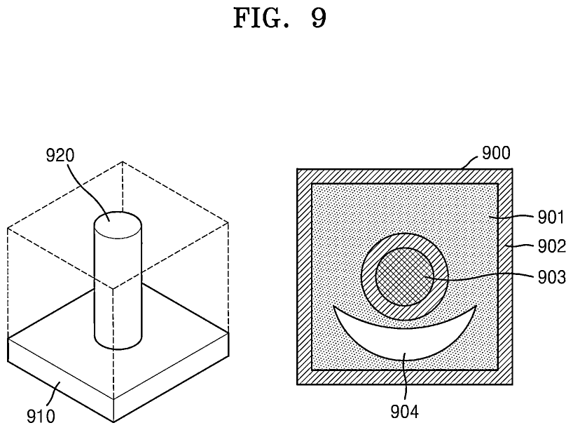

FIG. 9 is a diagram for describing a hologram guide and a guide area, according to an embodiment of the present disclosure. Hereinafter, descriptions of same configurations as configurations described with reference to FIG. 7 are omitted here.

Referring to FIGS. 2 and 9, in an embodiment, a hologram guide 920 that has a cylindrical shape and is provided on a display 910 is shown. It is shown that the hologram guide 920 has one reflection surface with a side surface shape of the cylinder.

In an embodiment, the at least one processor 340 (see FIG. 3) may obtain, from the hologram guide 920, information about the hologram guide 920, the information including at least one piece of information among information indicating that a type of the hologram guide 920 is the cylinder, a height of the hologram guide 920 and a perimeter of the cylinder, information indicating that the hologram guide 920 has one reflection surface, or a material of the one reflection surface.

In an embodiment, the at least one processor 340 may obtain information about a guide area 900, based on the obtained information about the hologram guide 920.

In an embodiment, the at least one processor 340 may obtain information indicating that the guide area 900 includes a plurality of sub-guide areas having different weights, based on the information about the hologram guide 920. In an embodiment, the plurality of sub-guide areas may include a first sub-guide area 901 having a first weight and a second sub-guide area 902 having a second weight smaller than the first weight.

An eye level of the user 270 who views the holographic image 260 may correspond to at least an intermediate height of a height of the reflection surface. As a holographic image provided on an area of the reflection surface, the area being adjacent to a surface on which the display 910 contacts the hologram guide 920, is different from the eye level of the user 270, a guide area corresponding to the area may be classified as the second sub-guide area 902. Due to a characteristic of the hologram guide 920 having the cylindrical shape, an image displayed in an area outside the guide area 900 may be less reflected by the hologram guide 920. Therefore, the area outside the guide area 900 may be classified as the second sub-guide area 902.

In an embodiment, a guide area corresponding to a reflection surface providing a holographic image corresponding to the eye level of the user 270 may be classified as the first sub-guide area 901.

However, the present disclosure is not limited thereto, and sizes and arrangements of the first sub-guide area 901 and the second sub-guide area 902 which are included in the guide area 900 may vary, according to a shape of the hologram guide 920, a height of the hologram guide 920, a perimeter of the hologram guide 920, a position and the eye level of the user 270 who receives the holographic image 260, or the like.

In an embodiment, the guide area 900 may further include a non-reflection area 903. The non-reflection area 903 may indicate an area of the display 910 in which the hologram guide 920 is provided, and an image displayed in the area may not be reflected by the hologram guide 920.

In an embodiment, the at least one processor 340 may determine, in the guide area 900, a display area 904 in which the base image 250 may be displayed with a weight greater than a preset threshold, based on the input image 240 and the information about the guide area 900. In an embodiment, the at least one processor 340 may convert the input image 240 into the base image 250, based on the determined display area 904, and may display the base image 250 in the display area 904. In this regard, the at least one processor 340 may convert the input image 240 into the base image 250 by using Cylinder Anamorphosis Formulas.

With reference to FIGS. 7 to 9, as an example, the hologram guides 720, 820, and 920 each having an inverted pyramid shape, a plane shape, or a cylindrical shape, and the guide areas 700, 800, and 900 corresponding to the hologram guides 720, 820, and 920 are shown, but the present disclosure is not limited thereto. A hologram guide may have a polygonal shape including a triangular pyramid, a round shape, etc., and a guide area may vary according to a shape of the hologram guide. Hereinafter, for convenience of descriptions, it is described that the hologram guide 720 has the inverted pyramid shape, and the guide area 700 is an area corresponding to the hologram guide 720 having the inverted pyramid shape.

FIG. 10 is a flowchart for describing an operation of an electronic device, according to an embodiment of the present disclosure. Hereinafter, descriptions of same operations as the operations described with reference to FIG. 4 are omitted.

Referring to FIGS. 2, 7, and 10, in an embodiment, after obtaining the information about the guide area 700 (S200), the operating method of the electronic device 100 may include checking whether indication information including information about a target image among the input image 240, the target image to be implemented as the holographic image 260, is received from a server or a neighboring electronic device which provides the input image 240 (S250).

In an embodiment, in the checking of whether the indication information including the information about the target image is received (S250), the at least one processor 340 may check, via the communication interface 350, whether the input image 240 and the indication information are received from the server or the neighboring electronic device which provides the input image 240. In an embodiment, when the indication information including the information about the target image among the input image 240, the target image to be implemented as the holographic image 260, is received from the server or the neighboring electronic device which provides the input image 240, in the determining of the display area 705 (S300_1), the display area 705 in which the base image 250 for implementing the target image as the holographic image 260 may be displayed may be determined, based on the input image 240, the information about the guide are 700, and the indication information.

In an embodiment, in the determining of the display area 705 (S300_1), the at least one processor 340 may determine the display area 705, based on the input image 240, the information about the guide are 700, and the indication information. In an embodiment, in the converting of the input image 240 into the base image 250 (S400_1), the input image 240 may be converted into the base image 250, based on the determined display area 705 and the indication information. In the converting of the input image 240 into the base image 250 (S400_1), the at least one processor 340 may convert the input image 240 into the base image 250, based on the determined display area 705 and the indication information.

In an embodiment, in the displaying of the base image 250 in the display area 705 (S500), the base image 250 that has been converted based on the determined display area 705 and the indication information may be displayed in the display area 705. In the displaying of the base image 250 in the display area 705 (S500), the at least one processor 340 may control the display 710 to display, in the display area 705, the base image 250 that has been converted based on the determined display area 705 and the indication information.

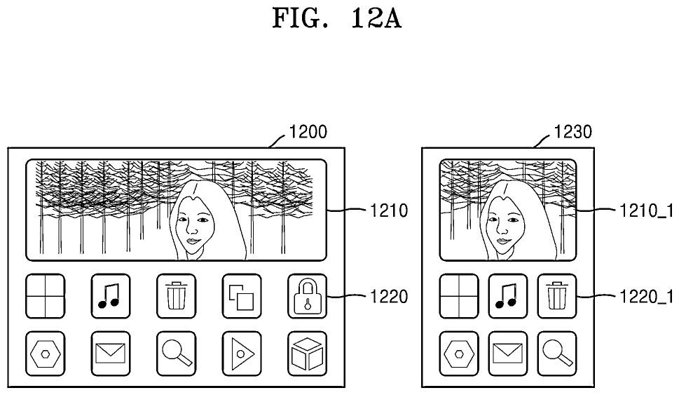

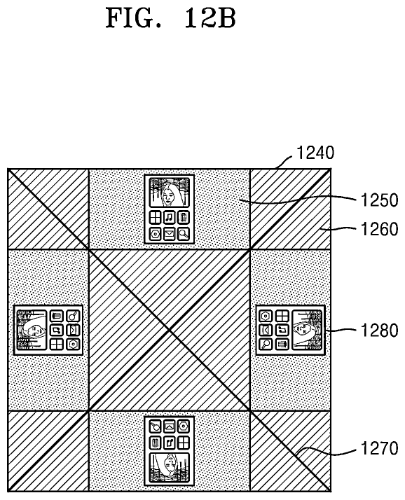

Hereinafter, a display area and a base image of a case in which the indication information including the information about the target image among the input image 240, the target image to be implemented as the holographic image 260, is received from the server or the neighboring electronic device which provides the input image 240 will be described in detail with reference to FIGS. 11A to 12B.

In an embodiment, when the indication information including the information about the target image is not received from the server or the neighboring electronic device which provides the input image 240, the operating method of the electronic device 100 may include checking whether tag information including information indicating that a portion of the input image 240 is a main image is obtained (S260).

In an embodiment, when the tag information including the information indicating that the portion of the input image 240 is the main image is obtained, in the determining of the display area 705 (S300_2), the display area 705 may be determined based on the input image 240, the information about the guide area 700, and the tag information.

In an embodiment, in the checking of whether the tag information is obtained (S260), the at least one processor 340 may check, via the communication interface 350, whether the tag information is obtained from the server or the neighboring electronic device which provides the input image 240, or the at least one processor 340 may identify the main image of the input image 240 and may check whether tag information including information about the identified main image is obtained.

In an embodiment, in the determining of the display area 705 (S300_2), the at least one processor 340 may determine the display area 705, based on the information about the guide area 700 and the tag information.

In an embodiment, in the converting of the input image 240 into the base image 250 (S400_2), the input image 240 may be converted into the base image 250, based on the determined display area 705 and the tag information. In the converting of the input image 240 into the base image 250 (S400_2), the at least one processor 340 may convert the input image 240 into the base image 250, based on the determined display area 705 and the tag information.

In an embodiment, in the displaying of the base image 250 in the display area 705 (S500), the base image 250 converted based on the determined display area 705 and the tag information may be displayed in the display area 705. In the displaying of the base image 250 in the display area 705 (S500), the at least one processor 340 may control the display 710 to display, in the display area 705, the base image 250 converted based on the determined display area 705 and the tag information.

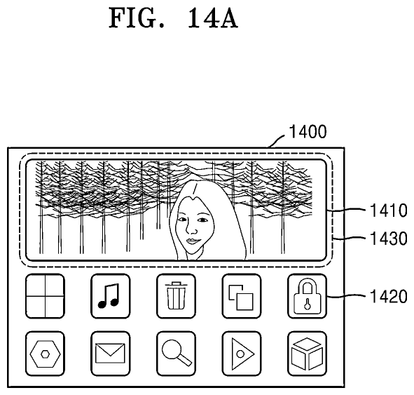

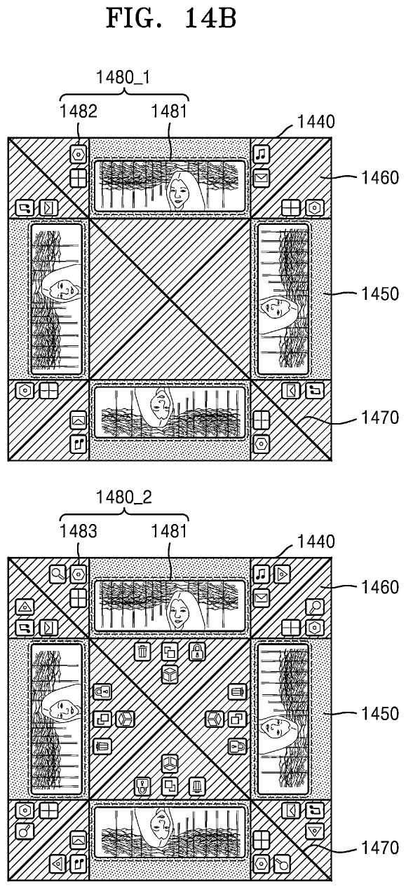

Hereinafter, a determined display area and a converted based image in a case in which the tag information including the information indicating that the portion of the input image 240 is the main image is obtained will be described in detail with reference to FIGS. 13A to 14B.

In an embodiment, when the tag information including the information indicating that the portion of the input image 240 is the main image is not obtained, in the determining of the display area 705 (S300_3), the display area 705 may be determined based on the input image 240 and the guide area 700.

In an embodiment, when the information about the guide area 700 includes information about the first sub-guide area 703 having the first weight and the second sub-guide area 704 having the second weight, an image among the base image 250 included in the guide area 700 so as to implement the holographic image 260, the image being displayed in the first sub-guide area 703, may be referred to as a first base image, and an image among the base image 250, the image being displayed in the second sub-guide area 704, may be referred to as a second base image. In the determining of the display area 705 (S300_3), the display area 705 may be determined so as to allow a weighted average of the first base image and the second base image to be greater than a preset threshold, the weighted average being calculated by using the first weight and the second weight.

In an embodiment, in the determining of the display area 705 (S300_3), the at least one processor 340 may calculate the weighted average of the first base image and the second base image by using the first weight and the second weight, based on the input image 240 and the information about the guide area 700, and may determine the display area 705 so as to allow the calculated weighted average to be greater than the preset threshold. The at least one processor 340 may adjust respective ratios of the first sub-guide area 703 and the second sub-guide area 704 to the display area 705, thereby adjusting a size of the weighted average of the base image 250 including the first base image and the second base image.

In an embodiment, in the converting of the input image 240 into the base image 250 (S400_3), the input image 240 may be converted into the base image 250, based on the display area 705.

In an embodiment, in the displaying of the base image 250 in the display area 705 (S500), the base image 250 converted based on the determined display area 705 may be displayed in the display area 705.

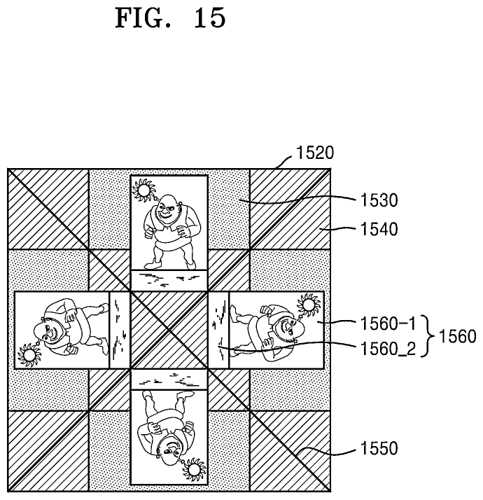

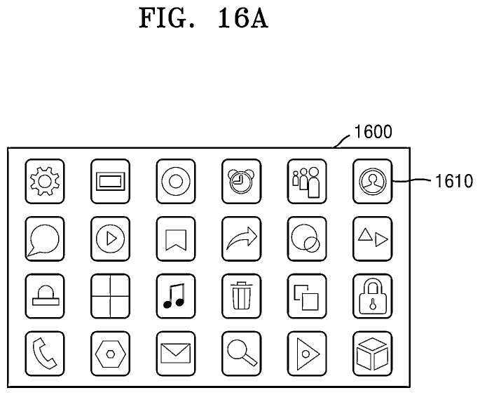

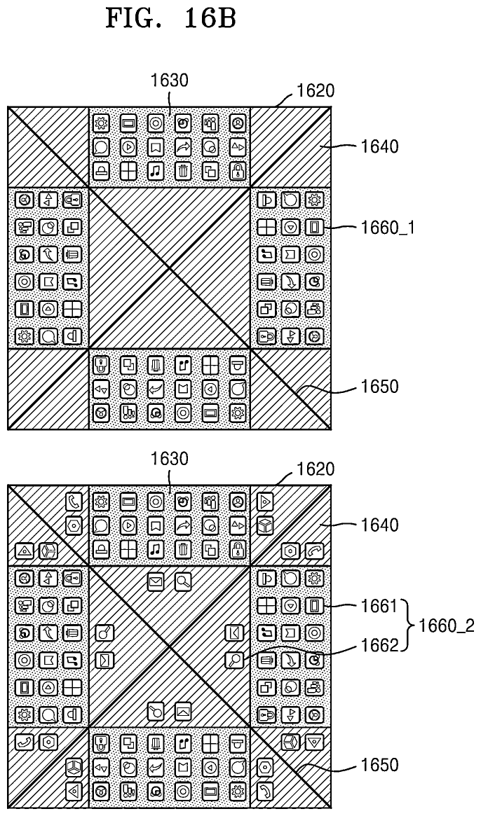

Hereinafter, a display area and a base image which are determined by using a weighted average will be described in detail with reference to FIGS. 15 to 16B.

FIG. 11A is a diagram for describing a target image among content, the target image to be implemented as a holographic image, according to an embodiment of the present disclosure. FIG. 11B is a diagram for describing a display area and a base image for implementing a target image as a holographic image, according to an embodiment of the present disclosure.

Hereinafter, with reference to FIGS. 11A and 11B, it is described that an input image is content. It is described that a target image among an input image, the target image to be implemented as a holographic image, is target content. It is described that a base image displayed in a display area so as to implement the target content as the holographic image is base content.

Referring to FIGS. 7, 10, and 11A, in an embodiment, FIG. 11A illustrates the content 1100 obtained by the at least one processor 340. The at least one processor 340 may receive indication information including information about the target content 1110 among the content 1100, the target content 1110 to be implemented as the holographic image 260 (see FIG. 2), from a server or a neighing electronic device providing the content 1100.

In an embodiment, when the holographic image 260 is implemented by using the base image 1160 (see FIG. 11B) converted from the content 1100, the target content 1110 may be content that the server or the neighing electronic device providing the content 1100 attempts to implement as the holographic image 260.

In an embodiment, FIG. 11A illustrates the target content 1110 as content corresponding to a portion of the content 1100. However, the present disclosure is not limited thereto, and the target content 1110 may be content obtained by partly revising content included in the content 1100.

In an embodiment, when the display 710 is not combined with the hologram guide 720, the at least one processor 340 may control the display 710 to display the content 1100. When the display 710 is combined with the hologram guide 720, the at least one processor 340 may control the display 710 to display, in a display area, the base content 1160 (see FIG. 11B) for implementing the target content 1110 as the hologram guide 260.

Referring to FIG. 11B, in an embodiment, a guide area 1120 may include a first sub-guide area 1130 having a first weight, a second sub-guide area 1140 having a second weight less than the first weight, and segmentation lines 1150 that classify a plurality of divided guide areas included in the guide area 1120. The at least one processor 340 may obtain the guide area 1120, based on the information about the hologram guide 720.

In an embodiment, based on the content 1100, the information about the guide area 1120, and the indication information, the at least one processor 340 may determine, in the guide area 1120, a display area in which the base content 1160 for implementing a target image as the hologram guide 260 is to be displayed.

In an embodiment, base content displayed in the first sub-guide area 1130 may be referred to as first base content, and base content displayed in the second sub-guide area 1140 may be referred to as second base content. According to Equation 1 below, by adjusting respective ratios of the first base content and the second base content to the base content, a weighted average of the base content may be determined.

$$WA = [ ( BIH \times WTH ) + ( BIL \times WTL ) ] / ( BIH + BIL ) \qquad Equation 1$$

Here, WA indicates the weighted average of the base content, BIH indicates a size of an area in which the first base image is to be displayed, BIL indicates a size of an area in which the second base image is to be displayed, WTH indicates a first weight of the first sub-guide area, and WTL indicates a second weight of the second sub-guide area.

The at least one processor 340 may determine a display area among the guide area 1120, by using the weighted average of the base content which is calculated using Equation 1. In an embodiment, the at least one processor 340 may determine a display area so as to allow the weighted average of the base content to be greater than a preset threshold. Hereinafter, for convenience of descriptions, it is described that the first weight is ‘1’, and the second weight has a value of ‘0’. In this regard, the weighted average of the base content has an integer value between 0 and 1.

Here, the threshold may be set according to a desired quality of the holographic image 260 to be implemented by the hologram guide 720 and an amount of information included in the holographic image 260. For example, when the at least one processor 340 sets the threshold to be close to ‘1’, a ratio of the weight of first base image to the weight of base image increases and a ratio of the second base image decreases. That is, when the threshold becomes closer to ‘1’, the display area is determined in such a manner that the base image is displayed in the first sub-guide area 1130 having the first weight in the guide area 1120, and the base image is not displayed in the second sub-guide area 1140 having the second weight, and thus, a quality of the holographic image 260 that the hologram guide 720 attempts to implement may be increased.

For example, when the at least one processor 340 sets the threshold to be close to ‘0’, the ratio of the first base image to the base image decreases and the ratio of the second base image increases, and thus, an amount of information included in the holographic image 260 that the hologram guide 720 attempts to implement may be increased. That is, when the threshold becomes closer to ‘0’, the display area is determined in such a manner that the base image is displayed not only in the first sub-guide area 1130 having the first weight in the guide area 1120 but also displayed in the second sub-guide area 1140 having the second weight, and thus, a size of the holographic image 260 that the hologram guide 720 attempts to implement may be increased. Therefore, the amount of information included in the holographic image 260 may be increased.

Therefore, the at least one processor 340 may determine the ratio of the first sub-guide area 1130 to the display area and the ratio of the second sub-guide area 1140 to the display area, based on a threshold set according to the quality and the amount of information of the holographic image 260 that the at least one processor 340 attempts to implement via the hologram guide 720. Also, the at least one processor 340 may change a size of the threshold, thereby changing the ratio of the first sub-guide area 1130 to the display area and the ratio of the second sub-guide area 1140 to the display area.

In an embodiment, the at least one processor 340 may identify a size and a shape of the target content 1110, based on the content 1100 and indication information. In an embodiment, the indication information may include coordinate information of an area corresponding to the target content 1110 among the content 1100. The at least one processor 340 may identify the size and the shape of the target content 1110 included in the content 1100, based on the coordinate information. However, the present disclosure is not limited thereto, and the indication information may include coordinate information, a size, and a shape of the target content 1110.

In an embodiment, the at least one processor 340 may determine a display area, based on the information about the guide area 1120, the ratio of the first sub-guide area 1130 to the determined display area and the ratio of the second sub-guide area 1140 to the determined display area, and the identified size and shape of the target content 1110.

In an embodiment, the at least one processor 340 may respectively compare sizes and shapes of the first sub-guide area 1130 and the second sub-guide area 1140 included in the guide area 1120 with the identified size and shape of the target content 1110, and thus, may determine a size and a shape of the base content 1160 so as to allow the base content 1160 to be included in the guide area 1120, the base content 1160 being for implementing the target content 1110 as the holographic image 260.

In an embodiment, the at least one processor 340 may determine ratios of the first base content and the second base content to the base content 1160 for implementing the target content 1110 as the holographic image 260, according to the ratio of the first sub-guide area 1130 to the determined display area and the ratio of the second sub-guide area 1140 to the determined display area.

In an embodiment, based on the determined size and shape of the base content 1160, and the determined first base content and second base content of the base content 1160, the at least one processor 340 may determine the display area in which the base content 1160 is to be displayed.

In an embodiment, the at least one processor 340 may convert the content 1100 to the base content 1160, based on the determined display area and the indication information. The at least one processor 340 may convert, via at least one of a resizing operation, a cropping operation, a rotating operation, or an overlaying operation, the target content 1110 identified based on the indication information into the base content 1160 to be displayed in the display area.

Referring to FIGS. 11A and 11B, FIG. 11B illustrates a display area determined when a threshold is set to ‘1’, and the base content 1160 displayed in the display area. When the threshold is set to ‘1’, the display area may be determined to include only the first sub-guide area 1130 and to allow the base content 1160 for implementing the identified target content 1110 to be displayed in the first sub-guide area 1130. In this regard, as the identified target content 1110 has a rectangular shape, the display area may be determined to have a rectangular shape, and the base content 1160 may be converted to have a rectangular shape.

In an embodiment, a size of the display area may be determined according to a quality and a size of the holographic image 260 to be implemented by the hologram guide 720. When the size of the display area increases, the size of the implemented holographic image 260 may increase. When the size of the display area decreases, the quality of the holographic image 260 may be improved. For example, when the size of the display area decreases, resolution of the holographic image 260 may be increased.

In an embodiment, as the hologram guide 720 has the inverted pyramid shape having four reflection surfaces, the display area includes four sub-display areas respectively corresponding to the four reflection surfaces. The at least one processor 340 may control the display 710 to display the base content 1160 in each of the four sub-display areas. Here, the base content 1160 displayed in each of the four sub-display areas may be rotated and displayed on the display 710 so as to face a center of the hologram guide 720 having the inverted pyramid shape.

FIG. 12A is a diagram for describing a target image among a GUI, the target image to be implemented as a holographic image, according to an embodiment of the present disclosure. FIG. 12B is a diagram for describing a display area and a base image for implementing a target image as a holographic image, according to an embodiment of the present disclosure. Hereinafter, descriptions of same configurations as configurations described with reference to FIGS. 11A and 11B are omitted.

Also, with reference to FIGS. 12A and 12B, it is described that an input image is a GUI. It is described that a target image among the input image, the target image to be implemented as a holographic image, is a target GUI. It is described that a base image displayed in a display area so as to implement target content as the holographic image is a base GUI.

Referring to FIGS. 7, 10, and 12A, in an embodiment, FIG. 12A illustrates a GUI 1200 obtained by the at least one processor 340. The at least one processor 340 may receive indication information including information about a target GUI 1230 among the GUI 1200, the target GUI 1230 to be implemented as the holographic image 260 (see FIG. 2), from a server or a neighboring electronic device providing the GUI 1200.

In an embodiment, the GUI 1200 may include at least one first icon 1210 and at least one second icon 1220 which include different information. FIG. 12A illustrates the GUI 1200 including one first icon 1210 and ten second icons 1220, but, the number, a size, an aspect ratio, and arrangement of each of the at least one first icon 1210 and the at least one second icon 1220 may vary according to information included in the GUI 1200.

In an embodiment, when a base GUI 1280 (see FIG. 12B) converted from the GUI 1200 is implemented as the holographic image 260 by using the hologram guide 720, the target GUI 1230 may be a GUI that the server or the neighboring electronic device providing the GUI 1200 attempts to implement as the holographic image 260.

FIG. 12A illustrates the target GUI 1230 including one first icon 1210_1 and six second icons 1220_1. A size and an aspect ratio of one first icon 1210_1 included in the target GUI 1230 may be different from a size and an aspect ratio of one first icon 1210 included in the GUI 1200. A size and the number of the second icons 1220_1 included in the target GUI 1230 may be different from a size and the number of the second icons 1220 included in the GUI 1200. Arrangements of the first icon 1210_1 and the second icon 1220_1 included in the target GUI 1230 may be different from arrangements of the first icon 1210 and the second icon 1220 included in the GUI 1200.

However, the present disclosure is not limited thereto, and only a size of the target GUI 1230 is different from a size of the GUI 1200, and the number, the aspect ratios, and the arrangements of the first and second icons included in the target GUI 1230 may be equal to the number, the aspect ratios, and the arrangements of the first and second icons included in the GUI 1200.

In an embodiment, when it is checked that the display 710 is not combined with the hologram guide 720, the at least one processor 340 may control the display 710 to display the GUI 1200. When it is checked that the display 710 is combined with the hologram guide 720, the at least one processor 340 may control the display 710 to display, in the display area 705, a base GUI 1280 for implementing the target GUI 1230 as the holographic image 260.

Referring to FIG. 12B, in an embodiment, based on the GUI 1200, information about a guide area 1240, and the indication information, the at least one processor 340 may determine, in the guide area 1240, a display area in which the base GUI 1280 for implementing the target GUI as the holographic image 260 is to be displayed.

In an embodiment, the guide area 1240 may include a first sub-guide area 1250 having a first weight and a second sub-guide area 1260 having a second weight less than the first weight.

In an embodiment, a base GUI displayed in the first sub-guide area 1250 may be referred to as a first base GUI, and a base GUI displayed in the second sub-guide area 1260 may be referred to as a second base GUI.

The at least one processor 340 may adjust respective ratios of the first base GUI and the second base GUI to the base GUI according to Equation 2 below, thereby determining a weighted average of the base GUI.

$$WB = [ ( BGH \times WTH ) + ( BGL \times WTL ) ] / ( BGH + BGL ) \qquad Equation 2$$

Here, WB indicates the weighted average of the base GUI, BGH indicates a size of an area in which the first base GUI is to be displayed, BGL indicates a size of an area in which the second base GUI is to be displayed, WTH indicates a first weight of the first sub-guide area, and WTL indicates a second weight of the second sub-guide area.

The at least one processor 340 may determine a display area among the guide area 1240, by using the weighted average of the base GUI which is calculated using Equation 2.

In an embodiment, the at least one processor 340 may identify the number, sizes, aspect ratios, arrangements, etc. of icons included in the target GUI 1230, based on the GUI 1200 and the indication information. In an embodiment, the indication information may include coordinate information of an area corresponding to the target GUI 1230 among the GUI 1200. The at least one processor 340 may identify, based on the coordinate information, the number, the sizes, the aspect ratios, the arrangements, etc. of the icons of the target GUI 1230 included in the GUI 1200.

However, the present disclosure is not limited thereto, and the indication information may include information about the number, the sizes, the aspect ratios, the arrangements, etc. of the icons included in the target GUI 1230.

In an embodiment, the at least one processor 340 may determine a display area, based on the information about the guide area 1240, the ratio of the first sub-guide area 1250 to the determined display area, the ratio of the second sub-guide area 1260 to the determined display area, and the identified size and shape of the target GUI 1230.

In an embodiment, the at least one processor 340 may convert the GUI 1200 into the base GUI 1280, based on the determined display area and the indication information. The at least one processor 340 may convert, via at least one of a resizing operation, a cropping operation, a rotating operation, or an overlaying operation, the target GUI 1230 identified based on the indication information into the base GUI 1280 to be displayed in the display area.

Referring to FIGS. 12A and 12B, FIG. 12B illustrates a display area determined when a threshold is set to ‘1’, and the base GUI 1280 displayed in the display area. In this regard, as the identified target GUI 1230 has a rectangular shape, the display area may be determined to have a rectangular shape, and the base GUI 1280 may be converted to have a rectangular shape.

In an embodiment, as the hologram guide 720 has the inverted pyramid shape having four reflection surfaces, the display area includes four sub-display areas respectively corresponding to the four reflection surfaces. The at least one processor 340 may control the display 710 to display the base GUI 1280 in each of the four sub-display areas. Here, the base GUI 1280 displayed in each of the four sub-display areas may be rotated and displayed on the display 710 so as to face a center of the hologram guide 720 having the inverted pyramid shape.

FIG. 13A is a diagram for describing a main image that is a portion of content, according to an embodiment of the present disclosure. FIG. 13B is a diagram for describing a display area and a base image for displaying a main image in a first sub-guide area, according to an embodiment of the present disclosure.

Hereinafter, descriptions of configurations overlapping configurations described with reference to FIGS. 11A and 11b are omitted. With reference to FIGS. 13A and 13B, it is described that an input image is content. It is described that a main image that is a portion of the input image is main content. It is described that a base image displayed in the display area is base content.

Referring to FIGS. 7, 10, and 13A, in an embodiment, FIG. 13A illustrates content 1300 obtained by the at least one processor 340. The at least one processor 340 may receive tag information including information indicating that a portion of the content 1300 is the main content 1310, from a server or a neighing electronic device providing the content 1300.

Here, the main content 1310 may be content that the server or the neighing electronic device providing the content 1300 determined that important information is included in information included in the content 1300. In an embodiment, when the content 1300 displays the upper body of a person on the front side and includes a background of a place in which the person is located, as the background of the upper body of the person, the server or the neighing electronic device providing the content 1300 may provide tag information including information indicating that the upper body of the person which is a portion of the content 1300 is the main content 1310.

In an embodiment, when the display 710 is not combined with the hologram guide 720, the at least one processor 340 may control the display 710 to display the content 1300. When the display 710 is combined with the hologram guide 720, the at least one processor 340 may control the display 710 to display, in the display, the base content 1360 (see FIG. 13B) converted from the 1300 so as to allow the implemented holographic image 260 to include information of the main content 1310.

In an embodiment, when the server or the neighing electronic device providing the content 1300 does not provide the tag information including the information indicating that the portion of the content 1300 is the main content 1310, the at least one processor 340 may identify the main content 1310, based on the content 1300. The at least one processor 340 may identify content (e.g., the upper body of the person, etc.) which occupies a largest area in the content 1300, as the main content. The at least one processor 340 may detect a boundary between the identified content and neighboring content, may crop the identified content, may overlay the identified content on a black background, etc., and then may identify the overlaid content as the main content.

Referring to FIG. 13B, in an embodiment, a guide area 1320 may include a first sub-guide area 1330 having a first weight, a second sub-guide area 1340 having a second weight less than the first weight, and segmentation lines 1350 that classify a plurality of divided guide areas included in the guide area 1320.

In an embodiment, based on the content 1300, the information about the guide area 1320, and the indication information, the at least one processor 340 may determine, in the guide area 1320, a display area in which the base content 1360 is to be displayed. In an embodiment, the base content 1360 may include first base content 1360_1 for implementing the main content 1310 as the holographic image 260, and second base content 1360_2 for implementing remaining content of the content 1300 excluding the main content 1310 as the holographic image 260.

In an embodiment, the at least one processor 340 may determine a display area so as to allow the first base content 1360_1 for implementing the main content 1310 to be displayed in an area having a greatest weight among a plurality of sub-guide areas included in the guide area 1320. In an embodiment, the first base content 1360_1 may be displayed in a first sub-guide area 1330, and the second base content 1360_2 may be displayed in a second sub-guide area 1340.

The at least one processor 340 may adjust respective ratios of the first base content 1360_1 and the second base content 1360_2 to the base content 1360, according to Equation 1, thereby determining a weighted average of the base content 1360.

The at least one processor 340 may determine a display area in the guide area 1120, by using the weighted average of the base content 1360 which is calculated according to Equation 1.

In an embodiment, the at least one processor 340 may identify a size and a shape of the main content 1310, based on the content 1300 and the tag information. In an embodiment, the tag information may include coordinate information of an area corresponding to the main content 1310 that is the portion of the content 1300. The at least one processor 340 may identify the size and the shape of the main content 1310 included in the content 1300, based on the coordinate information. However, the present disclosure is not limited thereto, and the tag information may include information about coordinate information, the size, and the shape of the main content 1310.

In an embodiment, the at least one processor 340 may determine a display area, based on the information about the guide area 1320, the ratio of the first sub-guide area 1330 to the determined display area and the ratio of the second sub-guide area 1340 to the determined display area, and the identified size and shape of the main content 1310.

In an embodiment, the at least one processor 340 may compare a size and a shape of the first sub-guide area 1330 included in the guide area 1320 with the identified size and shape of the main content 1310, and thus, may determine a size and a shape of the base content 1360 so as to allow the base content 1360 to be included in the guide area 1320, the base content 1360 being for implementing the main content 1310 as the holographic image 260.

In an embodiment, the at least one processor 340 may determine ratios of the first base content 1360_1 and the second base content 1360_2 to the base content 1360, according to the ratio of the first sub-guide area 1330 to the determined display area and the ratio of the second sub-guide area 1340 to the determined display area.

In an embodiment, based on the determined size and shape of the base content 1360, the determined ratio of the first base content to the base content 1360 and the determined ratio of the second base content to the base content 1360, the at least one processor 340 may determine the display area in which the base content 1360 is to be displayed.

In an embodiment, the at least one processor 340 may convert the content 1300 to the base content 1360, based on the determined display area and the indication information. Based on the tag information, the at least one processor 340 may convert, via at least one of a cropping operation, a resizing operation, a rotating operation, or an overlaying operation, the content 1300 into the base content 1360 to be displayed in the display area.

Referring to FIGS. 13A and 13B, FIG. 13B illustrates a display area determined when a threshold is set to a value less than ‘1’, and the base content 1360 displayed in the display area. The content 1300 may include the content 1310 that is content including a standing person, and remaining content such as a background (e.g., the ground, a rock, the moon, etc.) other than the standing person.

The base content 1360 may include the first base content 1360_1 for implementing the main content 1310 as the holographic image 260, and the second base content 1360_2 for implementing remaining content of as the holographic image 260.

The display area may include an area for displaying the first base content 1360_1 and an area for displaying the second base content 1360_2. The area for displaying the first base content 1360_1 may be included in the first sub-guide area 1330. The area for displaying the second base content 1360_2 may be included in the second sub-guide area 1340.

However, the present disclosure is not limited thereto. In an embodiment, when the at least one processor 340 sets the threshold as 1, the base content 1360 may include only the first base content 1360_1, and the display area may include an area included in the first sub-guide area 1330 so as to display the first base content 1360_1.

In an embodiment, when the at least one processor 340 sets the threshold value to be close to ‘1’, the holographic image 260 implemented by the hologram guide 720 may include only a holographic image with a high quality in which the main content 1310 is implemented. When the at least one processor 340 sets the threshold value to be close to ‘0’, the holographic image 260 implemented by the hologram guide 720 may include not only the holographic image in which the main content 1310 is implemented but also include a holographic image in which remaining content is implemented.

FIG. 14A is a diagram for describing a main image that is a portion of a GUI, according to an embodiment of the present disclosure. FIG. 14B is a diagram for describing a display area and a base image for displaying a main image in a first sub-guide area, according to an embodiment of the present disclosure. Hereinafter, descriptions of same configurations as configurations described with reference to FIGS. 11A to 13B are omitted.

With reference to FIGS. 14A and 14B, it is described that an input image is a GUI. It is described that a main image that is a portion of the input image is a main GUI. It is described that a base image displayed in a display area is a base GUI.

Referring to FIGS. 7, 10, and 14A, in an embodiment, FIG. 14A illustrates a GUI 1400 obtained by the at least one processor 340. The at least one processor 340 may receive tag information including information indicating that a portion of the GUI 1400 is a main GUI 1430, from a server or a neighboring electronic device which provided the GUI 1400.

In this regard, the main GUI 1430 may be a GUI that the server or the neighing electronic device provided the GUI 1400 determined that important information is included in information included in the GUI 1400.

In an embodiment, the GUI 1400 may include one first icon 1410 and ten second icons 1420. Here, the first icon 1410 may be an icon that provides information related to information about any second icon selected from among the ten second icons 1420. A size of the first icon 1410 may be greater than a size of the any second icon. The tag information may include information that the server or the neighing electronic device provided the GUI 1400 determined the first icon 1410 of the GUI 1400 as the main GUI 1430.

In an embodiment, when it is checked that the display 710 is not combined with the hologram guide 720, the at least one processor 340 may control the display 710 to display the GUI 1400. When it is checked that the display 710 is combined with the hologram guide 720, the at least one processor 340 may control the display 710 to display, in the display area, a base GUI 1480_1 and 1480_2 (see FIG. 14B) converted from the GUI 1400 so as to include information about the main GUI 1430.

Referring to FIG. 14B, in an embodiment, the guide area 1440 may include a first sub-guide area 1450 having a first weight, a second sub-guide area 1460 having a second weight less than the first weight, and segmentation lines 1470 that classify a plurality of divided guide areas included in the guide area 1440.

In an embodiment, based on the GUI 1400, information about the guide area 1440, and the indication information, the at least one processor 340 may determine, in the guide area 1440, display areas in which the base GUIs 1480_1 and 1480_2 are to be displayed. In an embodiment, the base GUIs 1480_1 and 1480_2 may include first base GUI 1481 for implementing the main GUI 1430 as the holographic image 260, and second base GUIs 1482 and 1483 for implementing a remaining GUI of the GUI 1400 excluding the main GUI 1430 as the holographic image 260.

In an embodiment, the at least one processor 340 may determine the display area so as to allow the first base GUI 1481 for implementing the main GUI 1430 to be displayed in an area having a greatest weight among the plurality of sub-guide areas included in the guide area 1440. In an embodiment, the first base GUI 1481 may be displayed in the first sub-guide area 1450, and the second base GUIs 1482 and 1483 may be displayed in the second sub-guide area 1460.

The at least one processor 340 may determine a weighted average by adjusting a ratio of the first base GUI 1481 and the second base GUI 1482 included in any one base GUI 1480_1 among the base GUIs 1480_1 and 1480_2 according to Equation 2. Also, the at least one processor 340 may determine a weighted average by adjusting a ratio of the first base GUI 1481 and the second base GUI 1483 included in the other one base GUI 1480_2 among the base GUIs 1480_1 and 1480_2 according to Equation 2.

The at least one processor 340 may determine a display area in the guide area 1440, by using the weighted average of the base GUIs 1480_1 and 1480_2 which is calculated using Equation 2.

In an embodiment, the at least one processor 340 may identify the number, sizes, aspect ratios, arrangements, etc. of icons included in the main GUI 1430, based on the GUI 1400 and target information. In an embodiment, tag information may include coordinate information of an area corresponding to the main GUI 1430 among the GUI 1400. The at least one processor 340 may identify the number, a size, an aspect ratio, arrangement, etc. of the main GUI 1430 included in the GUI 1400, based on the coordinate information. However, the present disclosure is not limited thereto, and indication information may include the number, sizes, aspect ratios, arrangements, etc. of icons included in the main GUI 1430, based on indication information.

In an embodiment, the at least one processor 340 may determine a display area, based on the information about the guide area 1440, ratios of the first sub-guide area 1450 and the second sub-guide area 1460 to the determined display area, and the identified size and shape of the main GUI 1430.

In an embodiment, the at least one processor 340 may convert the GUI 1400 into the base GUIs 1480_1 and 1480_2, based on the determined display information and the indication information.

In an embodiment, the at least one processor 340 may convert, via at least one of a cropping operation, a resizing operation, a rotating operation, or an overlaying operation, the target GUI 1430 into the first base GUI 1481 to be displayed in a display area in the first sub-guide area 1450, the display area being among the display area.

In an embodiment, the at least one processor 340 may convert, via at least one of a cropping operation, a resizing operation, a rotating operation, or an overlaying operation, a remaining GUI excluding the main GUI 1430 into the second base GUIs 1482 and 1483 to be displayed in a display in the second sub-guide area 1460, the display area being among the display area.

FIG. 14B illustrates the base GUI 1480_1 of a case in which a threshold is set to a first threshold less than ‘1’, and the base GUI 1480_2 for which a threshold is set to a value less than the first threshold.

In an embodiment, as the identified main GUI 1430 has a rectangular shape, when a threshold is set to a first threshold and a second threshold, an area in the display area to be included in the first sub-guide area 1450 may be determined to have a rectangular shape, and the first base GUI 1481 may be converted to have a rectangular shape.

In an embodiment, when a threshold becomes closer to ‘0’, a size of an area of the second sub-guide area 1460 to be included in the display area increases. When the threshold becomes closer to ‘0’, among the display area, a size of an area included in the first sub-guide area 1450 may be constant and the size of the area included in the second sub-guide area 1460 may increase.

In an embodiment, when the second sub-guide area 1460 is classified into guide areas having a plurality of different weight values, the area of the display area which is included in the second sub-guide area 1460 may include the guide areas in an order according to great weights.

In an embodiment, when the threshold becomes closer to ‘0’, a holographic image corresponding to the main GUI 1430 included in the holographic image 260 implemented by the hologram guide 720 may be constant and a holographic image corresponding to a remaining GUI may increase.

Therefore, a size of an area included in the second sub-guide area 1460, the area being included in a display area of a case where the threshold is set to the first threshold, may be less than a size of an area included in the second sub-guide area 1460, the area being included in a display area of a case where the threshold is set to the second threshold. The second base GUI 1482 of a case where the threshold is set to the first threshold may be less than the second base GUI 1483 of a case where the threshold is set to the second threshold.

The at least one processor 340 may differently set a size of a threshold, thereby adjusting a size of an area included in the second sub-guide area 1460.

In an embodiment, when the at least one processor 340 sets the size of the threshold to be closer to ‘1’, a size of an area included in the second sub-guide area 146, the area being included in the display area, may decrease, and the second base GUI 1482 may be decreased, so that a holographic image corresponding to the remaining GUI in the hologram guide 260 may be decreased. Accordingly, a quality of the holographic image 260 provided to the user 270 (e.g., one first icon 1410 whose quality of holographic image included in the holographic image 260 is high) may be increased.

In an embodiment, when the at least one processor 340 sets the size of the threshold to be closer to ‘0’, the size of the area included in the second sub-guide area 146, the area being included in the display area, may increase, and the second base GUI 1482 may be increased, so that a holographic image corresponding to the remaining GUI in the hologram guide 260 may be increased. Accordingly, an amount of information included in the holographic image 260 to be provided to the user 270 (e.g., the number of one or more second icons included in the holographic image 260 among the ten second icons 1420) may be increased.

FIG. 15 is a diagram for describing a display area and a base image determined so as to allow a weighted average of a first base image and a second base image of content to be greater than a preset threshold, according to an embodiment of the present disclosure.

Hereinafter, descriptions of same configurations as configurations described with reference to FIGS. 11A to 14B are omitted. With reference to FIG. 15, it is described that an input image is content, and a base image displayed in a display area is base content.

In an embodiment, a guide area 1520 may include a first sub-guide area 1530 having a first weight, a second sub-guide area 1540 having a second weight, and segmentation lines 1550 that classify a plurality of divided guide areas included in the guide area 1520.

In an embodiment, base content 1560 for implementing content 1500 as the holographic image 260 may include first base content 1560_1 to be displayed in the first sub-guide area 1530, and second base content 1560_2 to be displayed in the second sub-guide area 1540.

Referring to FIGS. 7, 10, 11A, and 15, the at least one processor 340 (see FIG. 3) may not receive indication information including information about target content 1110 among the content 1100, from the server or the neighboring electronic device which provides the content 1100. The at least one processor 340 may not receive target information including information about the main content 1310 (see FIG. 13A) among the content 1100 from the server or the neighboring electronic device providing the content 1100, and may not identify main content among the content 1100.

In an embodiment, when the at least one processor 340 does not obtain information about the target content 1110 or the main content 1310 among the content 1100, the at least one processor 340 may determine a display area so as to allow a weighted average of the base content 1560, which is calculated by using Equation 1, to be greater than a preset threshold.

In an embodiment, the at least one processor 340 may determine the display area, based on at least one of information about the guide area 1520, a ratio of the first sub-guide area 1530 to the determined display area, a ratio of the second sub-guide area 1540 to the determined display area, and a size and a shape of the content 1500.

In an embodiment, the at least one processor 340 may compare a size and a shape of the guide area 1520 with the size and the shape of the content 1500, and thus, may determine a size and a shape of the base content 1560 so as to allow the base content 1560 to be included in the guide area 1520, the base content 1560 being for implementing the content 1500 as the holographic image 260.

In an embodiment, the at least one processor 340 may determine a display area to display the base content 1560, based on the determined size and shape of the base content 1560, and ratios of the first sub-guide area 1530 and the second sub-guide area 1540 to the determined display area.

In an embodiment, the at least one processor 340 may convert the content 1500 into the base content 1560, based on the determined display area.

FIG. 15 illustrates a display area determined when a threshold is set to a value less than ‘1’, and the base content 1560 displayed in the displayed area. In an embodiment, when the at least one processor 340 sets a threshold to be closer to ‘1’, a size of an area of a display area, the area being included in the second sub-guide area 1540, may decrease, and a high-quality holographic image that is implemented from the base content 1560 and is displayed in an area of the display area, the area being included in the first sub-guide area 1530, may be provided.

In an embodiment, when the at least one processor 340 sets a threshold to be closer to ‘0’, a size of the second sub-guide area 1540 included in the display area may increase, and a holographic image with a large amount of information which is implemented from the base content 1560 and is displayed in the first sub-guide area 1530 and the second sub-guide area 1540 included in the display area may be provided.

FIG. 16A is a diagram for describing a GUI, according to an embodiment of the present disclosure. FIG. 16B is a diagram for describing a display area and a base image determined so as to allow a weighted average of a first base image and a second base image of a GUI to be greater than a preset threshold, according to an embodiment of the present disclosure.

Hereinafter, descriptions of same configurations as configurations described with reference to FIGS. 11A to 15 are omitted. With reference to FIGS. 16A and 16B, it is described that an input image is a GUI. It is described that a base image displayed in a display area is a base GUI.

Referring to FIGS. 7, 10, and 16A, FIG. 16A illustrates a GUI 1600 obtained by the at least one processor 340.

In an embodiment, the GUI 1600 may include a plurality of icons 1610. While FIG. 16A illustrates the GUI 1600 including 24 icons 1610, the present disclosure is not limited thereto, and may include icons less than 24 or icons equal to or greater than 25. While FIG. 16 illustrates the 24 icons 1610 having the same size and the same aspect ratio and arranged at regular intervals, the present disclosure is not limited thereto. A size, arrangement, and an aspect ratio of each of icons included in the GUI 1600 may vary.

Referring to FIG. 16B, in an embodiment, a guide area 1620 may include a first sub-guide area 1630 having a first weight, a second sub-guide area 1640 having a second weight less than the first weight, and segmentation lines 1650 that classify a plurality of divided guide areas included in the guide area 1620.

In an embodiment, a base GUI 1660_1 and 1660_2 for implementing the GUI 1600 as the holographic image 260 may include a first base GUI 1661 displayed in a first sub-guide area 1630 and a second base GUI 1662 displayed in a second sub-guide area 1640.

The at least one processor 340 (see FIG. 3) may not receive the indication information including the information about the target GUI 1230 (see FIG. 12A) among the GUI 1600 from the server or the neighboring electronic device providing the GUI 1600. The at least one processor 340 may not receive target information including information about the main GUI 1430 (see FIG. 14A) among the GUI 1600 from the server or the neighboring electronic device providing the GUI 1600, and may not identify main content among the GUI 1600.

In an embodiment, when the at least one processor 340 does not obtain information about the target GUI 1230 or the main GUI 1430 among the GUI 1600, the at least one processor 340 may determine a display area so as to allow a weighted average of the base GUI 1660_1 and 1660_2, which is calculated by using Equation 2, to be greater than a preset threshold.

In an embodiment, the at least one processor 340 may identify the number, sizes, aspect ratios, arrangements, etc. of the plurality of icons 1610 included in the GUI 1600.

In an embodiment, the at least one processor 340 may determine the display area, based on at least one of the information about the guide area 1620, a ratio of the first sub-guide area 1630 to the determined display area, a ratio of the second sub-guide area 1640 to the determined display area, and the identified number, the identified sizes, the identified aspect ratios, or the identified arrangements of the plurality of icons 1610.

In an embodiment, the at least one processor 340 may convert the GUI 1600 into the base GUI 1660_1 and 1660_2, based on the determined display area.

FIG. 16B illustrates the base GUI 1660_1 of a case in which a threshold is set to a first threshold that is ‘1’, and the base GUI 1660_2 of a case in which the threshold is set to a value less than the first threshold.

In an embodiment, when the threshold becomes closer to ‘1’, a size of an area included in the second sub-guide area 1640 among the display area decreases. When the threshold becomes closer to ‘1’, it is possible to provide a high quality holographic image that is displayed in an area among the display area, the area being included in the first sub-guide area 1630, and in which the base GUI 1660_1 and 1660_2 is implemented.

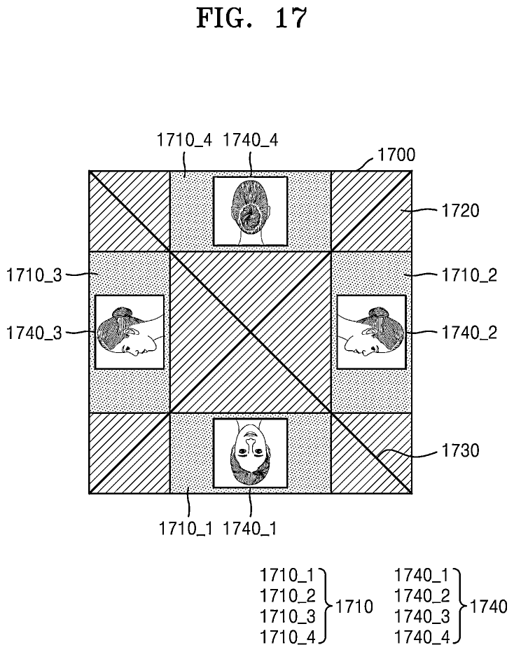

FIG. 17 is a diagram for describing that a plurality of base images are displayed in a display area, the plurality of base images being implemented as different sides of a holographic image on respective front sides of a plurality of reflection surfaces, according to an embodiment of the present disclosure. Hereinafter, descriptions of same configurations as configurations described with reference to FIGS. 2, 7A, and 11B are omitted.

Referring to FIGS. 2, 7, 11A, and 17, FIG. 17 illustrates a guide area 1700 of a case in which the hologram guide 720 having the inverted pyramid shape is connected to the display 710. The guide area 1700 may include a first sub-guide area 1710 having a first weight, a second sub-guide area 1720 having a second weight, and segmentation lines 1730 that classify four divided guide areas included in the guide area 1700.

FIG. 17 illustrates a case in which a threshold is set to ‘1’, and thus, a display area is included in the first sub-guide area 1710. A base image 1740 displayed in display areas respectively included in the four divided guide areas may be implemented as the holographic image 260 by the hologram guide 720.

In an embodiment, the first sub-guide area 1710 included in each of the four divided guide areas may be defined as a first sub-guide area 1710_1, a second sub-guide area 1710_2, a third sub-guide area 1710_3, and a fourth sub-guide area 1710_4. The display areas respectively included in the first to fourth sub-guide areas 1710_1, 1710_2, 1710_3, and 1710_4 may be defined as a first sub-display area, a second sub-display area, a third sub-display area, and a fourth sub-display area. The base image 1740 may include a first base image 1740_1 displayed in the first sub-display area, a second base image 1740_2 displayed in the second sub-display area, a third base image 1740_3 displayed in the third sub-display area, and a fourth base image 1740_4 displayed in the fourth sub-display area.

In an embodiment, the at least one processor 340 may convert an input image into the base image 1740 so as to implement the holographic image 260 whose shape provided to the user 270 varies according to a position of the user 270 who views the holographic image 260 provided by the hologram guide 720. For example, when the hologram guide 720 has the inverted pyramid shape and includes the four reflection surfaces, the at least one processor 340 may convert the input image into the base image 1740 so as to implement the holographic image 260 to be provided, to the user 270, as four different sides on front sides of the four reflection surfaces.

In an embodiment, the hologram guide 720 may have the four reflection surfaces, and the first to fourth sub-display areas may respectively correspond to the four reflection surfaces. The at least one processor 340 may respectively display, in the first to fourth sub-display areas, the first to fourth base images 1740_1, 1740_2, 1740_3, and 1740_4 for implementing different sides of the holographic image 260.

In an embodiment, when the input image is an image displaying a scene of an object and a background including three-dimensional (3D) information at the front side, the first to fourth base images 1740_1, 1740_2, 1740_3, and 1740_4 may be base images for implementing, as the holographic image 260, respective images displaying scenes of the object and the background including 3D information at the front side, the right side, the left side, and the back side.

In an embodiment, when the at least one processor 340 obtains a 3D image including the 3D information of the object and the background, in order to display the input image, the at least one processor 340 may obtain a front side image, based on the 3D image, and then may display the obtained front side image as the input image.

In order to obtain the first to fourth base images 1740_1, 1740_2, 1740_3, and 1740_4 to implement the holographic image 260 whose provision to the user 270 varies according to a position of the user 270 who views the holographic image 260, the at least one processor 340 may obtain a front side image, a right side image, a left side image, and a back side image, based on the 3D image, and may convert the obtained images into the first to fourth base images 1740_1, 1740_2, 1740_3, and 1740_4.

The holographic image 260 implemented, by using the hologram guide 720, from the first to fourth base images 1740_1, 1740_2, 1740_3, and 1740_4 respectively displayed in the first to fourth sub-display areas may be implemented as different sides of the holographic image 260 on respective front sides of the four reflection surfaces. Therefore, the user 270 who views the holographic image 260 implemented by the electronic device 100 (see FIG. 1) of the present disclosure may view other sides of the holographic image 260 according to positions of the user 270, so that a stereoscopic effect experienced by the user 270 may be improved.

In an embodiment, among the first to fourth sub-display areas, a sub-display area in which the first base image 1740_1 converted from the front side image is to be displayed may be determined according to position information of the user 270 who views the holographic image 260. In an embodiment, the at least one processor 340 may determine, by using the user tracking sensor 320 (see FIG. 3), the sub-display area to display the first base image 1740_1 to display a front side of the holographic image 260 at an initial position of the user 270 who views the holographic image 260.

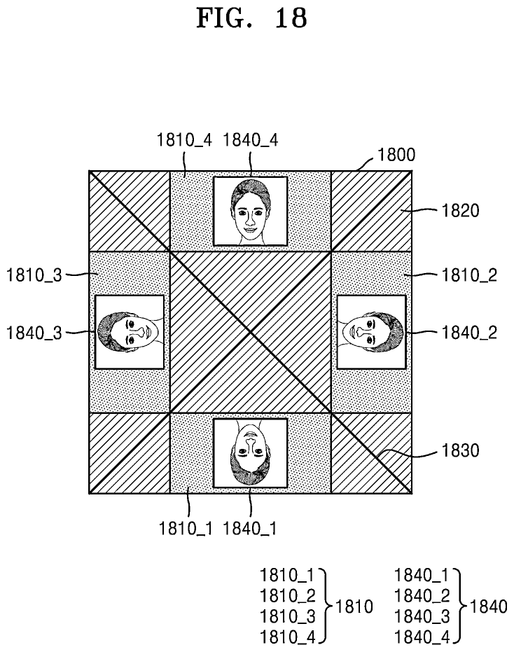

FIG. 18 is a diagram for describing that a plurality of base images are displayed in a display area, the plurality of base images being implemented as the same side of a holographic image on respective front sides of a plurality of reflection surfaces, according to an embodiment of the present disclosure. Hereinafter, descriptions of same configurations as configurations described with reference to FIG. 17 are omitted.

Referring to FIGS. 2, 7, 11A, and 18, FIG. 18 illustrates a guide area 1800 of a case in which the hologram guide 720 having the inverted pyramid shape is connected to the display 710. The guide area 1800 may include a first sub-guide area 1810 having a first weight, a second sub-guide area 1820 having a second weight, and segmentation lines 1830 that classify four divided guide areas included in the guide area 1800.

In an embodiment, the first sub-guide area 1810 included in each of the four divided guide areas may be defined as a first sub-guide area 1810_1, a second sub-guide area 1810_2, a third sub-guide area 1810_3, and a fourth sub-guide area 1810_4. The display areas respectively included in the first to fourth sub-guide areas 1810_1, 1810_2, 1810_3, and 1810_4 may be defined as a first sub-display area, a second sub-display area, a third sub-display area, and a fourth sub-display area. The base image 1840 may include a first base image 1840_1 displayed in the first sub-display area, a second base image 1840_2 displayed in the second sub-display area, a third base image 1840_3 displayed in the third sub-display area, and a fourth base image 1840_4 displayed in the fourth sub-display area.

In an embodiment, the at least one processor 340 may convert an input image into the base image 1840 so as to implement the holographic image 260 whose shape provided to the user 270 is constant, regardless of a position of the user 270 who views the holographic image 260 provided by the hologram guide 720. For example, when the hologram guide 720 has the inverted pyramid shape and includes the four reflection surfaces, the at least one processor 340 may convert the input image into the base image 1840 so as to implement the holographic image 260 to be provided, to the user 270, as the same side on front sides of the four reflection surfaces.

In an embodiment, when the input image is an image displaying a scene of an object and a background including 3D information at the front side, the first to fourth base images 1840_1, 1840_2, 1840_3, and 1840_4 may be base images for implementing, as the holographic image 260, an image displaying a scene of the object and the background including 3D information at any one of the front side, the right side, the left side, and the back side.

The holographic image 260 implemented, by using the hologram guide 720, from the first to fourth base images 1840_1, 1840_2, 1840_3, and 1840_4 respectively displayed in the first to fourth sub-display areas may be implemented as the same side of the holographic image 260 on respective front sides of the four reflection surfaces. Therefore, even when positions of two or more users who view the holographic image 260 implemented by the electronic device 100 (see FIG. 1) of the present disclosure are different from each other, the users may view the same side of the holographic image 260.

In an embodiment, the operating method of the electronic device 100 may include receiving indication information including information about a target image among the input image, the target image to be implemented as the holographic image, from a server or a neighboring electronic device which provides the input image. In the determining of the display area (S300_1), the display area in which the base image for implementing the target image as the holographic image may be displayed may be determined, based on the input image, the information about the guide are, and the indication information. In the converting of the input image into the base image (S400_1), the input image may be converted into the base image, based on the determined display area and the indication information.

In an embodiment, the operating method of the electronic device 100 may include receiving tag information including information indicating that a portion of the input image is a main image. In the determining of the display area 705 (S300_2), the display area may be determined, based on the input image, the information about the guide area, and the tag information, so as to allow the base image for implementing the main image to be displayed in an area having a greatest weight among the plurality of sub-guide areas. In the converting of the input image 240 into the base image 250 (S400_2), the input image may be converted into the base image, based on the determined display area and the tag information.

In an embodiment, the plurality of different weights may include a first weight and a second weight less than the first weight. The plurality of sub-guide areas may include a first sub-guide area having the first weight and a second sub-guide area having the second weight. The base image may include a first base image to be displayed in the first sub-guide area and a second base image to be displayed in the second sub-guide area. In the determining of the display area (S300_3), the operating method may include determining the display area so as to allow a weighted average of the first base image and the second base image to be greater than a preset threshold, the weighted average being calculated by using the first weight and the second weight. A ratio of the second base image to the base image may decrease as the preset threshold increases.

In an embodiment, when the hologram guide (120) includes a plurality of reflection surfaces, the display area includes a plurality of display surfaces respectively corresponding to the plurality of reflection surfaces. In the converting of the input image into the base image (S400), the input image may be converted into a plurality of base images, based on the determined display area, so as to allow the holographic image to be implemented as a same side on respective front sides of the plurality of reflection surfaces, the holographic image being implemented by reflecting the plurality of base images. In the displaying of the base image in the display area (S500), the plurality of base images may be respectively displayed on the plurality of display surfaces.

A program executable by the electronic device described in the present disclosure may be implemented as a hardware element, a software element, and/or a combination of hardware elements and software elements. The program is executable by any system capable of executing computer-readable instructions.

The software may include a computer program, code, instructions, or a combination of one or more thereof, and may configure the processor to operate as desired or may independently or collectively instruct the processor.

The software may be implemented as a computer program that includes instructions stored in computer-readable storage media. The computer-readable storage media may include, for example, magnetic storage media (e.g., a read-only memory (ROM), a random-access memory (RAM), floppy disks, hard disks, etc.) and optical storage media (e.g., a compact disc ROM (CD-ROM), a digital versatile disc (DVD), etc.). The computer-readable recording medium may be distributed in computer systems connected via a network and may store and execute computer-readable code in a distributed manner. The recording medium is readable by a computer, stored in a memory, and executable by a processor.

The computer-readable storage medium may be provided in the form of a non-transitory storage medium. Here, the term “non-transitory storage medium” may mean that the storage medium is a tangible device and does not include signals (e.g., electromagnetic waves), and may mean that data may be permanently or temporarily stored in the storage medium. For example, the “non-transitory storage medium” may include a buffer in which data is temporarily stored.

In addition, a program according to embodiments disclosed in the present specification may be provided in a computer program product. The computer program product may be traded as commodities between sellers and buyers.

The computer program product may include a software program and a computer-readable recording medium storing the software program. For example, the computer program product may include a product (e.g., a downloadable application) in the form of a software program electronically distributed via a manufacturer of the electronic device or an electronic market (e.g., Samsung Galaxy Store). For electronic distribution, at least part of the software program may be stored in a storage medium or temporarily generated. In this case, the storage medium may be a storage medium of a server of the manufacturer of the electronic device, a server of the electronic market, or a relay server for temporarily storing the S/W program.

While the disclosure has been illustrated and described with reference to one or more embodiments, it will be understood that the one or more embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiments described herein may be used in conjunction with any other embodiments described herein.

What is claimed is:

1. An electronic device comprising:
a display;
memory storing at least one instruction; and
at least one processor configured to execute the at least one instruction stored in the memory,
wherein the at least one instruction, when executed by the at least one processor, causes the electronic device to:
obtain an input image,
obtain information about a guide area of the display, the guide area comprising a plurality of sub-guide areas having a plurality of different weights with respect to implementation of a holographic image, the holographic image being implemented via a hologram guide by reflecting a base image that is based on the input image,
determine a display area in the guide area, in which the base image can be displayed to have a weight greater than a preset threshold, based on the input image and the information about the guide area,
convert the input image into the base image based on the display area, and
display the base image in the display area.

2. The electronic device of claim 1, wherein the at least one instruction, when executed by the at least one processor, further causes the electronic device to:
determine whether the display is connected to the hologram guide,
based on determining that the display is connected to the hologram guide, display the base image in the display area of the display, and
based on determining that the display is not connected to the hologram guide, display the input image on the display.

3. The electronic device of claim 2, wherein the at least one instruction, when executed by the at least one processor, further causes the electronic device to:
receive information about the hologram guide from the hologram guide, and
obtain the information about the guide area based on the information about the hologram guide,
wherein the information about the hologram guide comprises at least one of a type of the hologram guide, a shape of the hologram guide, a number of at least one reflection surface of the hologram guide, an angle formed between the at least one reflection surface and the display, or a material of the at least one reflection surface.

4. The electronic device of claim 1, wherein the plurality of different weights comprise a first weight, a second weight less than the first weight, and a third weight less than the second weight,
wherein the plurality of sub-guide areas comprise a first sub-guide area having the first weight, a second sub-guide area having the second weight, and a third sub-guide area having the third weight, and
wherein a distance between the first sub-guide area and the second sub-guide area is less than a distance between the first sub-guide area and the third sub-guide area.

5. The electronic device of claim 1, wherein the at least one instruction, when executed by the at least one processor, further causes the electronic device to:
receive, from a server or a neighboring electronic device which provides the input image, indication information comprising information about a target image based on the input image, the target image to be implemented as the holographic image;
determine, based on the input image, the information about the guide area, and the indication information, the display area in which the base image for implementing the target image as the holographic image is to be displayed,
convert the input image into the base image based on the display area and the indication information, and
display the base image in the display area.

6. The electronic device of claim 1, wherein the at least one instruction, when executed by the at least one processor, further causes the electronic device to:
receive tag information comprising information indicating a portion of the input image as a main image,
determine, based on the input image, the information about the guide area, and the tag information, the display area for allowing the base image for implementing the main image to be displayed in an area having a greatest weight among the plurality of sub-guide areas,
convert the input image into the base image based on the display area and the tag information; and
display the base image in the display area.

7. The electronic device of claim 1, wherein the plurality of different weights comprise a first weight and a second weight less than the first weight,
wherein the plurality of sub-guide areas comprise a first sub-guide area having the first weight and a second sub-guide area having the second weight,
wherein the base image comprises a first base image to be displayed in the first sub-guide area and a second base image to be displayed in the second sub-guide area,
wherein the at least one instruction, when executed by the at least one processor, further causes the electronic device to determine the display area for allowing a weighted average of the first base image and the second base image to be greater than the preset threshold, the weighted average being calculated by using the first weight and the second weight, and
wherein a ratio of the second base image to the base image decreases as the preset threshold increases.

8. The electronic device of claim 1, wherein the input image comprises at least one of content or a graphical user interface.

9. The electronic device of claim 1, wherein the hologram guide comprises a plurality of reflection surfaces,
wherein the display area comprises a plurality of display surfaces respectively corresponding to the plurality of reflection surfaces, and
wherein the at least one instruction, when executed by the at least one processor, further causes the electronic device to:
convert, based on the display area, the input image into a plurality of base images for allowing the holographic image to be implemented on a same side of respective front sides of the plurality of reflection surfaces, the holographic image being implemented via the hologram guide by reflecting the plurality of base images, and
display the plurality of base images respectively on the plurality of display surfaces.

10. The electronic device of claim 1, wherein the hologram guide comprises a plurality of reflection surfaces,
wherein the display area comprises a plurality of display surfaces respectively corresponding to the plurality of reflection surfaces, and
wherein the at least one instruction, when executed by the at least one processor, further causes the electronic device to:
convert, based on the display area, the input image into a plurality of base images for allowing the holographic image to be implemented on different sides of respective front sides of the plurality of reflection surfaces, the holographic image being implemented via the hologram guide by reflecting the plurality of base images, and
display the plurality of base images respectively on the plurality of display surfaces.

11. An operating method of an electronic device, the operating method comprising:
obtaining an input image;
obtaining information about a guide area of a display of the electronic device, the guide area comprising a plurality of sub-guide areas having a plurality of different weights with respect to implementation of a holographic image, the holographic image being implemented via a hologram guide by reflecting a base image based on the input image;
determining a display area in the guide area, in which the base image can be displayed, based on the input image and the information about the guide area, the base image having a weight greater than a preset threshold;
converting the input image into the base image based on the display area; and
displaying the base image in the display area.

12. The operating method of claim 11, further comprising:
determining whether the display is connected to the hologram guide;
based on determining that the display is connected to the hologram guide, displaying the base image in the display area on the display, and
based on determining that the display is not connect to the hologram guide, displaying the input image on the display.

13. The operating method of claim 12, further comprising:
receiving information about the hologram guide from the hologram guide; and
obtaining information about the guide area based on the information about the hologram guide,
wherein the information about the hologram guide comprises at least one of a type of the hologram guide, a shape of the hologram guide, a number of at least one reflection surface of the hologram guide, an angle formed between the at least one reflection surface and the display, or a material of the at least one reflection surface.

14. The operating method of claim 11, wherein the plurality of different weights comprise a first weight, a second weight less than the first weight, and a third weight less than the second weight,
wherein the plurality of sub-guide areas comprise a first sub-guide area having the first weight, a second sub-guide area having the second weight, and a third sub-guide area having the third weight, and
wherein a distance between the first sub-guide area and the second sub-guide area is less than a distance between the first sub-guide area and the third sub-guide area.

15. The operating method of claim 11, further comprising:
receiving information comprising information about a target image among the input image, the target image to be implemented as the holographic image, from a server or a neighboring electronic device which provides the input image,
wherein the determining of the display area comprises determining the display area in which the base image for implementing the target image as the holographic image is displayed, based on the input image, the information about the guide area, and the indication information, and
wherein the converting of the input image into the base image comprises converting the input image into the base image, based on the determined display area and the indication information.

16. The operating method of claim 11, further comprising:
receiving tag information comprising information indicating that a portion of the input image is a main image,
wherein the determining of the display area comprises determining the display area, based on the input image, the information about the guide area and the tag information so as to allow the base image for implementing the main image to be displayed in an area having a greatest weight among the plurality of sub-guide areas, and
wherein the converting of the input image into the base image comprises converting the input image into the base image, based on the determined display area and the tag information.

17. The operating method of claim 11, wherein the plurality of different weights comprise a first weight and a second weight less than the first weight,
wherein the plurality of sub-guide areas comprises a first sub-guide area having the first weight and a second sub-guide area having the second weight,
wherein the base image comprises a first base image to be displayed in the first sub-guide area and a second base image to be displayed in the second sub-guide area,
wherein the determining of the display area comprises determining the display area so as to allow a weighted average of the first base image and the second base image to be greater than a preset threshold, the weighted average being calculated by using the first weight and the second weight, and
wherein a ratio of the second base image to the base image decreases as the preset threshold increases.

18. The operating method of claim 11, wherein the input image comprises at least one of content or a graphical user interface.

19. The operating method of claim 11, wherein the hologram guide comprises a plurality of reflection surfaces, and the display area comprises a plurality of display surfaces respectively corresponding to the plurality of reflection surfaces,
wherein the converting of the input image into the base image comprises converting the input image into a plurality of base images, based on the determined display area, so as to allow the holographic image to be implemented as the same side on respective front sides of the plurality of reflection surfaces, the holographic image is implemented by reflecting the plurality of base images, and
wherein the displaying of the base image in the display area comprises displaying the plurality of base images, respectively, on the plurality of display surfaces.

20. A non-transitory computer-readable storage medium having recorded thereon a program for performing the operating method of claim 11.
